(19) United States
(12) Patent Application Publication
(10) Pub. No.: US 2026/0107261 A1
(43) Pub. Date: Apr. 16, 2026

(54) UPLINK RESOURCE MUTING RELATED UE CAPABILITIES

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US); Peter GAAL, San Diego, CA (US)

(21) Appl. No.: 18/917,931

(22) Filed: Oct. 16, 2024

(51) Int. Cl. H04W 72/044

(52) U.S. Cl. CPC H04W 72/044

(57) ABSTRACT

The apparatus may be a wireless device such as a user equipment (UE) configured to transmit an indication of support by the UE for UL resource muting associated with one or more of: UL resource muting activation, a number of UL resource muting time location configurations supported by the UE, UL resource muting time location configuration switching, a use of zero power (ZP) sounding reference signals (SRS) resources for the UL resource muting, one or more UL waveforms, one or more transmission types, a maximum number of muted symbols in a time window, a slot type, power boosting of unmuted physical UL shared channel (PUSCH) resources, a minimum frequency domain allocation, or a minimum time domain allocation, and receive, based on the indication, at least one UL resource muting configuration supported by the UE.

### TECHNICAL FIELD

The present disclosure relates generally to communication systems, and more particularly, to an uplink (UL) transmission in a wireless communication environment.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) configured to transmit an indication of support by the UE for UL resource muting associated with one or more of: UL resource muting activation, a number of UL resource muting time location configurations supported by the UE, UL resource muting time location configuration switching, a use of zero power (ZP) sounding reference signals (SRS) resources for the UL resource muting, one or more UL waveforms, one or more transmission types, a maximum number of muted symbols in a time window, a slot type, power boosting of unmuted physical UL shared channel (PUSCH) resources, a minimum frequency domain allocation of a PUSCH to which the UL resource muting may be applied, or a minimum time domain allocation of the PUSCH to which the UL resource muting may be applied, and receive, based on the indication, at least one UL resource muting configuration supported by the UE.

In an aspect of the disclosure, a method, a computer-readable medium, and an apparatus are provided. The apparatus may be a network device such as a base station configured to receive an indication of support by a UE for UL resource muting associated with one or more of: UL resource muting activation, a number of UL resource muting time location configurations supported by the UE, UL resource muting time location configuration switching, a use of ZP SRS resources for the UL resource muting, one or more UL waveforms, one or more transmission types, a maximum number of muted symbols in a time window, a slot type, power boosting of unmuted PUSCH resources, a minimum frequency domain allocation of a PUSCH to which the UL resource muting may be applied, or a minimum time domain allocation of the PUSCH to which the UL resource muting may be applied, and transmit, based on the indication, at least one UL resource muting configuration supported by the UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A shows a first example of full-duplex communication in which a first base station is in full duplex communication with a first UE and a second UE.

FIG. 4B shows a second example of full-duplex communication in which a first base station is in full-duplex communication with a first UE.

FIG. 4C shows a third example of full-duplex communication in which a first UE is a full-duplex UE in communication with a first base station and a second base station.

FIGS. 5A-5B illustrate a first example and a second example of in-band full duplex (IBFD) resources in accordance with some aspects of the disclosure.

FIG. 5C illustrates an example of sub-band full-duplex resources in accordance with some aspects of the disclosure.

FIG. 6 is a diagram illustrating different time locations for a first and second symbol that may be configured for UL resource muting in accordance with some aspects of the disclosure.

FIG. 7A is a diagram illustrating a first timeline associated with UL resource muting in accordance with some aspects of the disclosure.

FIG. 7B is a diagram illustrating a second timeline associated with switching between different UL resource muting time location configurations in accordance with some aspects of the disclosure.

FIG. 8 is a call flow diagram illustrating a method of wireless communication in accordance with some aspects of the disclosure.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

FIG. 14 is a diagram illustrating an example of a hardware implementation for an example network entity.

FIG. 15 is a diagram illustrating an example of a hardware implementation for an example network entity.

### DETAILED DESCRIPTION

In some aspects of wireless communication, full duplex and/or sub-band full duplex (SBFD) communication may be associated with cross link interference (CLI). To measure CLI at a network device and/or a first UE, in some aspects, UL resource muting (which may be referred to as UL muting, resource muting, UL Tx muting, or as muting in some contexts) may be applied by a set of UEs associated with the network device. The resources associated with the UL resource muting, in some aspects, may be aligned with resources used to measure the CLI from other network devices and/or UEs (not in the set of UEs applying UL resource muting) at the network device and/or the first UE. In some aspects, different UEs may be capable of performing different aspects of UL resource muting (e.g., may support different features of UL resource muting).

Various aspects relate generally to defining a feature list for UL resource muting for inter-base station CLI handling, e.g., capabilities related to UL resource muting including support for various configurations, patterns, waveforms, switching, and/or UL channel types. Some aspects more specifically relate to a UE capability indication (or a set of indications) to indicate whether a UE supports one or more of various features of UL resource muting. In some examples, a wireless device may be configured to transmit an indication of support by the UE for UL resource muting associated with one or more of: UL resource muting activation, a number of UL resource muting time location configurations supported by the UE, UL resource muting time location configuration switching, a use of ZP SRS resources for the UL resource muting, one or more UL waveforms, one or more transmission types, a maximum number of muted symbols in a time window, a slot type, power boosting of unmuted PUSCH resources, a minimum frequency domain allocation of a PUSCH to which the UL resource muting may be applied, or a minimum time domain allocation of the PUSCH to which the UL resource muting may be applied, and receive, based on the indication, at least one UL resource muting configuration supported by the UE. A network device such as a base station, in some aspects, may be configured to receive an indication of support by a UE for UL resource muting associated with one or more of: UL resource muting activation, a number of UL resource muting time location configurations supported by the UE, UL resource muting time location configuration switching, a use of ZP SRS resources for the UL resource muting, one or more UL waveforms, one or more transmission types, a maximum number of muted symbols in a time window, a slot type, power boosting of unmuted PUSCH resources, a minimum frequency domain allocation of a PUSCH to which the UL resource muting may be applied, or a minimum time domain allocation of the PUSCH to which the UL resource muting may be applied, and transmit, based on the indication, at least one UL resource muting configuration supported by the UE.

Particular aspects of the subject matter described in this disclosure can be implemented to realize one or more of the following potential advantages. In some examples, by transmitting a UE capability indication (or a set of indications), the described techniques can be used to optimize UL resource muting for CLI measurement.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

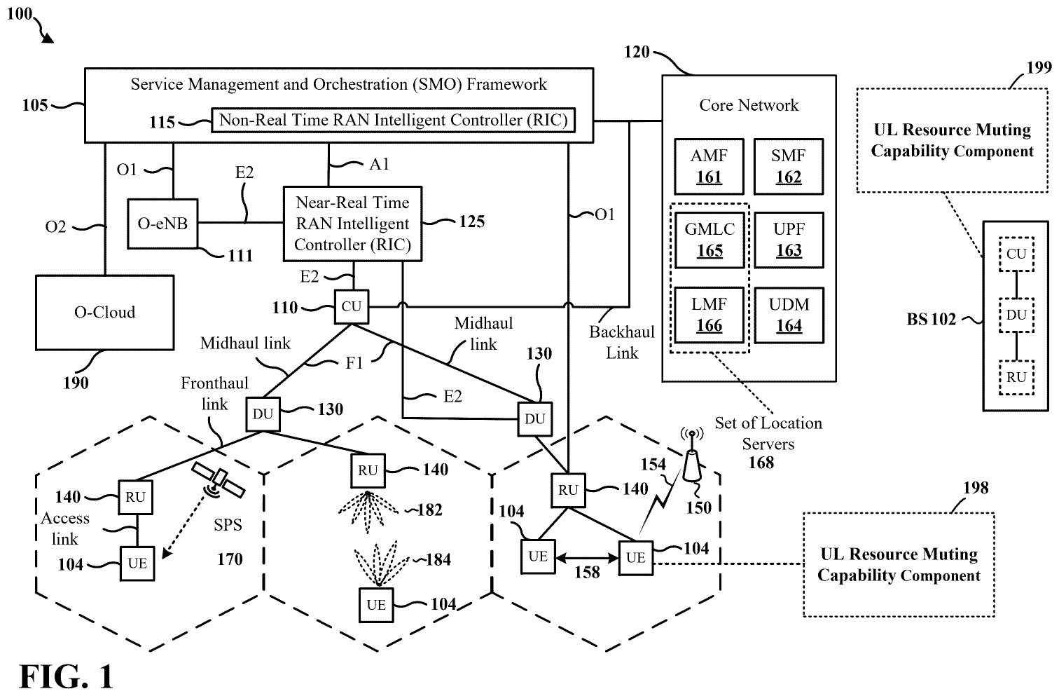

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface).

Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an UL resource muting capability component 198 that may be configured to transmit an indication of support by a UE for UL resource muting associated with one or more of: UL resource muting activation, a number of UL resource muting time location configurations supported by the UE, UL resource muting time location configuration switching, a use of ZP SRS resources for the UL resource muting, one or more UL waveforms, one or more transmission types, a maximum number of muted symbols in a time window, a slot type, power boosting of unmuted PUSCH resources, a minimum frequency domain allocation of a PUSCH to which the UL resource muting may be applied, or a minimum time domain allocation of the PUSCH to which the UL resource muting may be applied, and receive, based on the indication, at least one UL resource muting configuration supported by the UE. In certain aspects, the base station 102 may have an UL resource muting capability component 199 that may be configured to receive an indication of support by a UE for UL resource muting associated with one or more of: UL resource muting activation, a number of UL resource muting time location configurations supported by the UE, UL resource muting time location configuration switching, a use of ZP SRS resources for the UL resource muting, one or more UL waveforms, one or more transmission types, a maximum number of muted symbols in a time window, a slot type, power boosting of unmuted PUSCH resources, a minimum frequency domain allocation of a PUSCH to which the UL resource muting may be applied, or a minimum time domain allocation of the PUSCH to which the UL resource muting may be applied, and transmit, based on the indication, at least one UL resource muting configuration supported by the UE. Although the following description may be focused on 5G NR, the concepts described herein may be applicable to other similar areas, such as LTE, LTE-A, CDMA, GSM, and other wireless technologies.

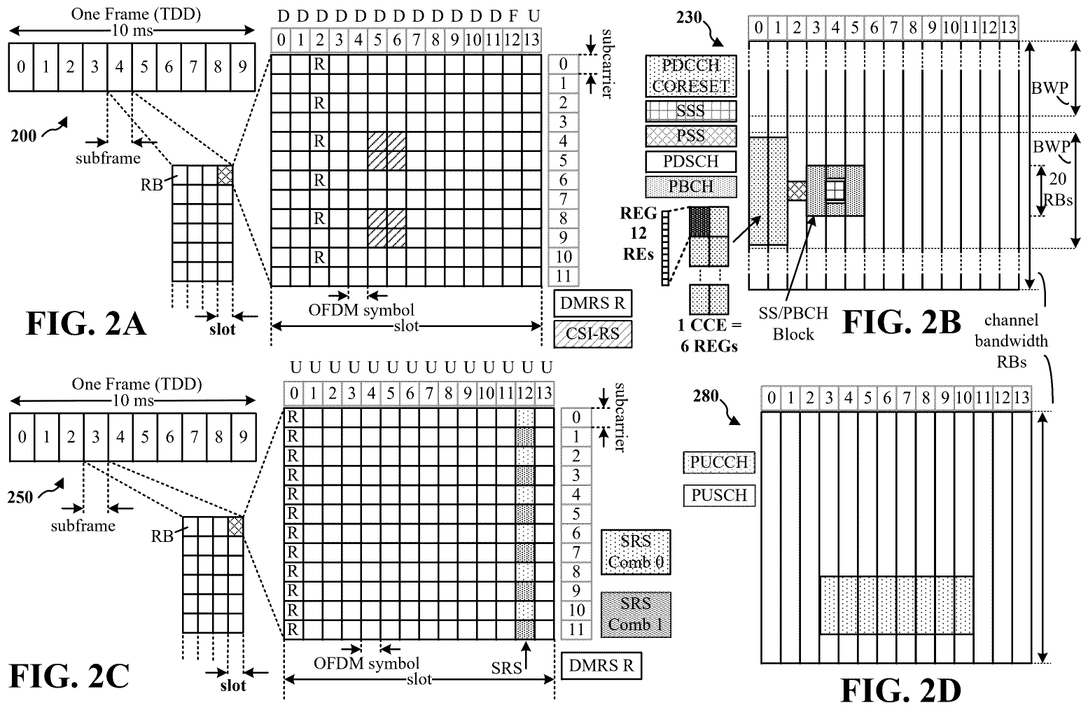

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2″ slots/subframe. The subcarrier spacing may be equal to 2″*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

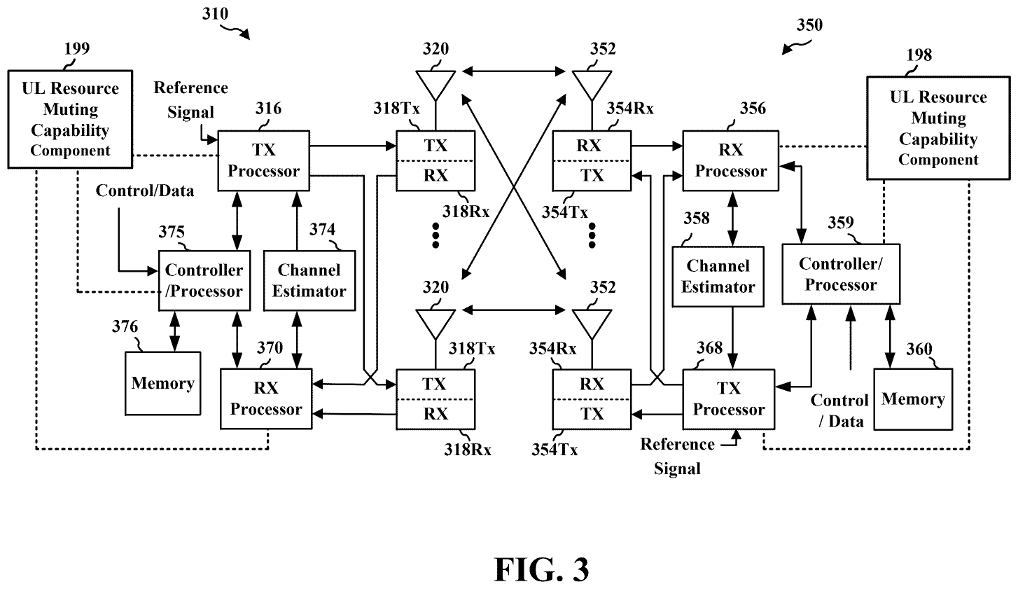

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the UL resource muting capability component 198 of FIG. 1.

At least one of the TX processor 316, the RX processor 370, and the controller/processor 375 may be configured to perform aspects in connection with the UL resource muting capability component 199 of FIG. 1.

In some aspects of wireless communication, full duplex and/or SBFD communication may be associated with CLI. To measure CLI at a network device and/or a first UE, in some aspects, UL resource muting may be applied by a set of UEs associated with the network device. The resources associated with the UL resource muting, in some aspects, may be aligned with resources used to measure the CLI from other network devices and/or UEs (not in the set of UEs applying UL resource muting) at the network device and/or the first UE. In some aspects, different UEs may be capable of performing different aspects of UL resource muting (e.g., may support different features of UL resource muting).

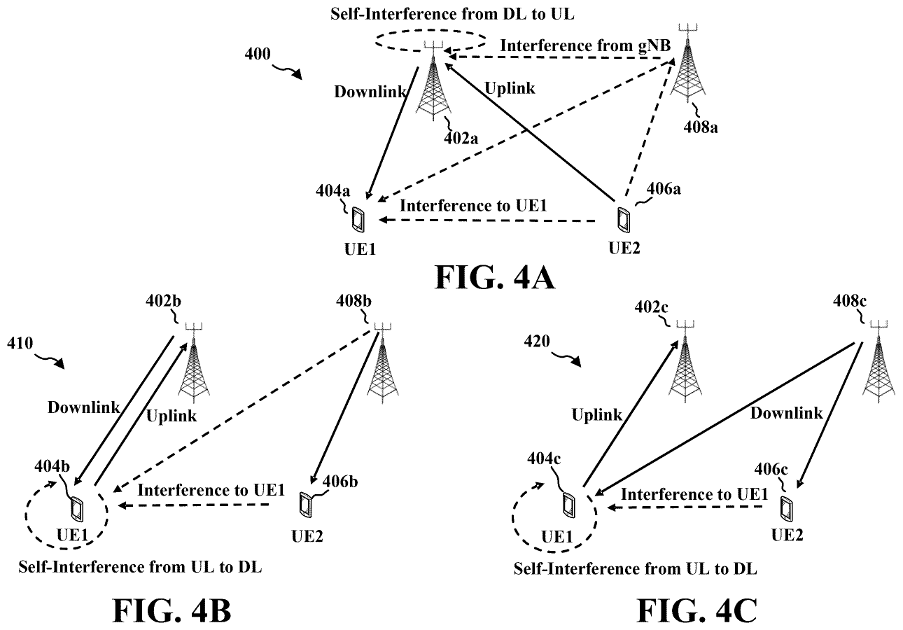

FIGS. 4A-4C illustrate various modes of full-duplex communication. Full-duplex communication supports transmission and reception of information over a same frequency band in a manner that overlap in time. In this manner, spectral efficiency may be improved with respect to the spectral efficiency of half-duplex communication, which supports transmission or reception of information in one direction at a time without overlapping uplink and downlink communication. Due to the simultaneous Tx/Rx nature of full-duplex communication, a UE or a base station may experience self-interference caused by signal leakage from its local transmitter to its local receiver. In addition, the UE or base station may also experience interference from other devices, such as transmissions from a second UE or a second base station. Such interference (e.g., self-interference or interference caused by other devices) may impact the quality of the communication, or even lead to a loss of information.

FIG. 4A shows a first example of full-duplex communication 400 in which a first base station 402a is in full duplex communication with a first UE 404a and a second UE 406a. The first base station 402a is a full-duplex base station, whereas the first UE 404a and the second UE 406a may be configured as either a half-duplex UE or a full-duplex UE. The second UE 406a may transmit a first uplink signal to the first base station 402a as well as to other base stations, such as a second base station 408a in proximity to the second UE 406a. The first base station 402a may transmit a downlink signal to the first UE 404a concurrently with receiving the uplink signal from the second UE 406a. The base station 402a may experience self-interference from the receiving antenna that is receiving the uplink signal from UE 406a receiving some of the downlink signal being transmitted to the UE 404a. The base station 402a may experience additional interference due to signals from the second base station 408a. Interference may also occur at the first UE 404a based on signals from the second base station 408a as well as from uplink signals from the second UE 406a (e.g., inter-cell CLI if the second UE 406a is in a different cell, or intra-cell CLI if the second UE 406a is in a same cell as the first UE 404a). As will be explained in more detail below the interference may be in-band or inter-band (or inter-sub-band) based on the full duplex mode of the different base stations and UEs.

FIG. 4B shows a second example of full-duplex communication 410 in which a first base station 402b is in full-duplex communication with a first UE 404b. In this example, the first base station 402b is a full-duplex base station and the first UE 404b is a full-duplex UE, e.g., the first base station 402b and the UE 404b can concurrently receive and transmit communication that overlaps in time in a same frequency band. The base station and the UE may each experience self-interference, in which a transmitted signal from the device is leaked to a receiver at the same device. The first UE 404b may experience additional interference based on one or more signals emitted from a second UE 406b and/or a second base station 408b in proximity to the first UE 404b.

FIG. 4C shows a third example of full-duplex communication 420 in which a first UE 404c is a full-duplex UE in communication with a first base station 402c and a second base station 408c. The first base station 402c and the second base station 408c may serve as multiple transmission and reception points (multi-TRPs) for UL and DL communication with the UE 404c. The second base station 408c may be in communication with a second UE 406c. In FIG. 4C, the first UE 404c may concurrently transmit an uplink signal to the first base station 402c while receiving a downlink signal from the second base station 408c. The first UE 404c may experience self-interference as a result of the first signal and the second signal being communicated simultaneously, e.g., the uplink signal may leak to, or be received by, the UE's receiver. The first UE 404c may experience additional interference from the second UE 406c.

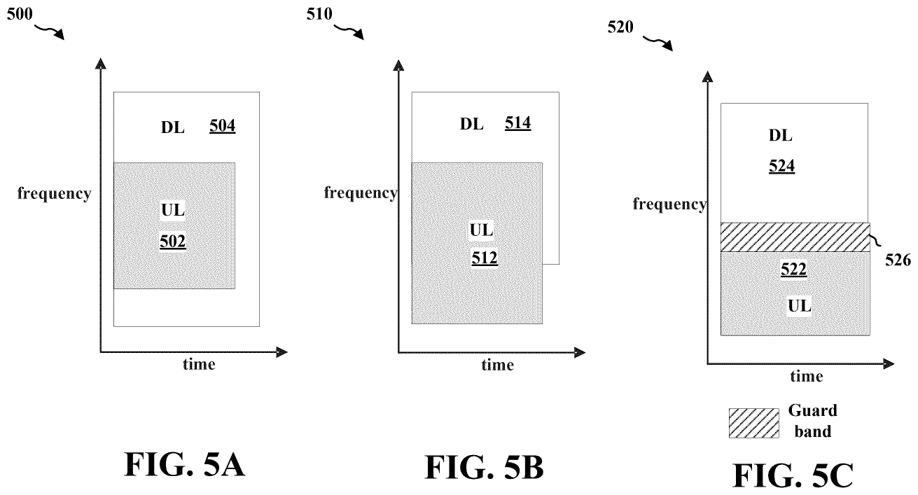

FIGS. 5A-5B illustrate a first example 500 and a second example 510 of in-band full duplex (IBFD) resources in accordance with some aspects of the disclosure. FIG. 5C illustrates an example 520 of sub-band full-duplex resources in accordance with some aspects of the disclosure. In IBFD, signals may be transmitted and received in overlapping times and via overlapping frequencies. As shown in the first example 500, a time and a frequency allocation of a set of UL resources 502 may fully overlap with a time and a frequency allocation of DL resources 504. In the second example 510, a time and a frequency allocation of UL resources 512 may partially overlap with a time and a frequency of allocation of DL resources 514.

IBFD may be contrasted with SBFD, where uplink and downlink resources may overlap in time using different frequencies, as shown in FIG. 5C. As shown in FIG. 5C, the UL resources 522 are separated from the DL resources 524 by a guard band 526. The guard band may be frequency resources, or a gap in frequency resources, provided between the UL resources 522 and the DL resources 524. Separating the UL frequency resources and the DL frequency resources with a guard band may help to reduce self-interference. UL resources and a DL resources that are immediately adjacent to each other correspond to a guard band width of 0. As an output signal, e.g., from a UE transmitter may extend outside the UL resources, the guard band may reduce interference experienced by the UE. SBFD may also be referred to as “flexible duplex”.

A slot format may be referred to as a “D+U” slot when the slot has a frequency band that is used for both uplink and downlink transmissions. The downlink and uplink transmissions may occur in overlapping frequency resources, such as shown in FIGS. 5A and 5B (e.g., in-band full duplex resources) or may occur in adjacent or slightly separated frequency resources, such as shown in FIG. 5C (e.g., SBFD resources). In a particular D+U symbol, a half-duplex device may either transmit in the uplink band or receive in the downlink band. In a particular D+U symbol, a full-duplex device may transmit in the uplink band and receive in the downlink band, e.g., in the same symbol or in the same slot. A D+U slot may include downlink only symbols, uplink only symbols, and full-duplex symbols.

In some aspects, CLI handling may be associated with one or more of: an information exchange of semi-static cell-specific SBFD time and frequency location configuration(s); an information exchange of measurement resource configuration(s) (e.g., SSB and/or periodic NZP CSI-RS); an information exchange of strongest DL beam information; an information exchange of CLI-mitigation request(s); and/or UL resource muting for PUSCH. The UL resource muting for PUSCH, in some aspects, may be associated with one or more of: an indication and/or determination of UL resource muting for PUSCH based on a semi-static configuration, PUSCH resource mapping, and/or UCI resource determination in symbols with muted REs. In some aspects, the indication and/or determination of the UL resource muting for PUSCH based on a semi-static configuration may be associated with, or assume, a comb-2 for both DFT-S-OFDM and CP-OFDM in each allocated PRB and up to 2 symbols in time domain. In some aspects, no new DCI field and/or MAC-CE may be introduced. The PUSCH resource mapping, in some aspects, may be associated with rate-matching around the muted REs and there may be no impact on data and control multiplexing. In some aspects, UL resource muting may not apply for certain types of transmissions, such as Msg A PUSCH and Msg 3 PUSCH. UL resource muting may apply for UEs in RRC_CONNECTED mode, and a UE may assume that the UL resource muting pattern does not overlap UL DM-RS or PT-RS in the same symbol. Power boosting, in some aspects, may be assumed for REs in the symbol with UL resource muting, where the power boosting ensures that PUSCH transmit power does not change across symbols. In some aspects, there may be no changes on TBS determination for PUSCH.

In some aspects, an L1-based UE-to-UE CLI measurement and reporting based on existing CSI framework including one or more of: measurement resources, measurement reporting, and/or CLI measurement accuracy requirement. The measurement resources, in some aspects, may be a periodic, semi-persistent, or aperiodic measurement resource (set), i.e., an SRS-RSRP resource or a CLI-RSSI resource. In some aspects, the measurement resources for SRS-RSRP may be based on the existing or legacy RS patterns without change to SRS configuration information exchange between base stations. The framework for measurement resources, in some aspects, may include configuration and/or determination of ‘typeD’ QCL assumptions for the CLI measurement resource. The measurement reporting, in some aspects, may include at least aperiodic reporting and may further include periodic and semi-persistent reporting. In some aspects, new report quantities, such as L1-SRS-RSRP, L1-CLI-RSSI and/or measurement resource indices may be provided for at least wideband reporting. The existing framework for measurement reporting may relate to the generation of UCI bits and/or priority rules for multiple CSI reporting, where the existing CSI processing unit, CPU occupation rule and timeline for L1 beam reporting may be reused for L1 UE-to-UE CLI measurement and reporting as a starting point.

Various aspects relate generally to defining a feature list for UL resource muting for inter-base station and/or inter-gNB CLI handling, e.g., capabilities related to UL resource muting including support for various configurations, patterns, waveforms, switching, and/or UL channel types. Some aspects more specifically relate to a UE capability indication (or a set of indications) to indicate support for different features of UL resource muting. In some examples, a wireless device may be configured to transmit an indication of support by the UE for UL resource muting associated with one or more of: UL resource muting activation, a number of UL resource muting time location configurations supported by the UE, UL resource muting time location configuration switching, a use of ZP SRS resources for the UL resource muting, one or more UL waveforms, one or more transmission types, a maximum number of muted symbols in a time window, a slot type, power boosting of unmuted PUSCH resources, a minimum frequency domain allocation of a PUSCH to which the UL resource muting may be applied, or a minimum time domain allocation of the PUSCH to which the UL resource muting may be applied, and receive, based on the indication, at least one UL resource muting configuration supported by the UE. A network device such as a base station, in some aspects, may be configured to receive an indication of support by a UE for UL resource muting associated with one or more of: UL resource muting activation, a number of UL resource muting time location configurations supported by the UE, UL resource muting time location configuration switching, a use of ZP SRS resources for the UL resource muting, one or more UL waveforms, one or more transmission types, a maximum number of muted symbols in a time window, a slot type, power boosting of unmuted PUSCH resources, a minimum frequency domain allocation of a PUSCH to which the UL resource muting may be applied, or a minimum time domain allocation of the PUSCH to which the UL resource muting may be applied, and transmit, based on the indication, at least one UL resource muting configuration supported by the UE.

Particular aspects of the subject matter described in this disclosure can be implemented to realize one or more of the following potential advantages. In some examples, by transmitting a UE capability indication (or a set of indications), the described techniques can be used to optimize UL resource muting for CLI measurement.

In some aspects relating to UL resource muting, the time location configuration of UL resource muting for a PUSCH may be based on one of: a semi-statically configured position for each of the up to two UL muting symbols within a slot, or a semi-statically configured set of one or more, e.g., N, where N≥1, possible positions for each of the up to two UL muting symbols within a slot. A semi-statically configured set of one or more possible positions for each of the up to two UL muting symbols within the slot, in some aspects, may include a first semi-statically configured set of N₁, where N₁≥1, possible positions for a first symbol within the slot and a second semi-statically configured set of N₂, where N₂≥1, possible positions for a second symbol within the slot, where N₂ may be the same as, or different from, N₁. In some aspects, the semi-statically configured set of one or more possible positions for each of the up to two UL muting symbols within the slot may include one or more patterns of muted symbols within the slot (e.g., may specify a time location for each of the up to two symbols within a slot). A reference point for the time location of the UL resource muting symbols, in some aspects, may be a starting symbol of a slot for both PUSCH mapping type A and type B.

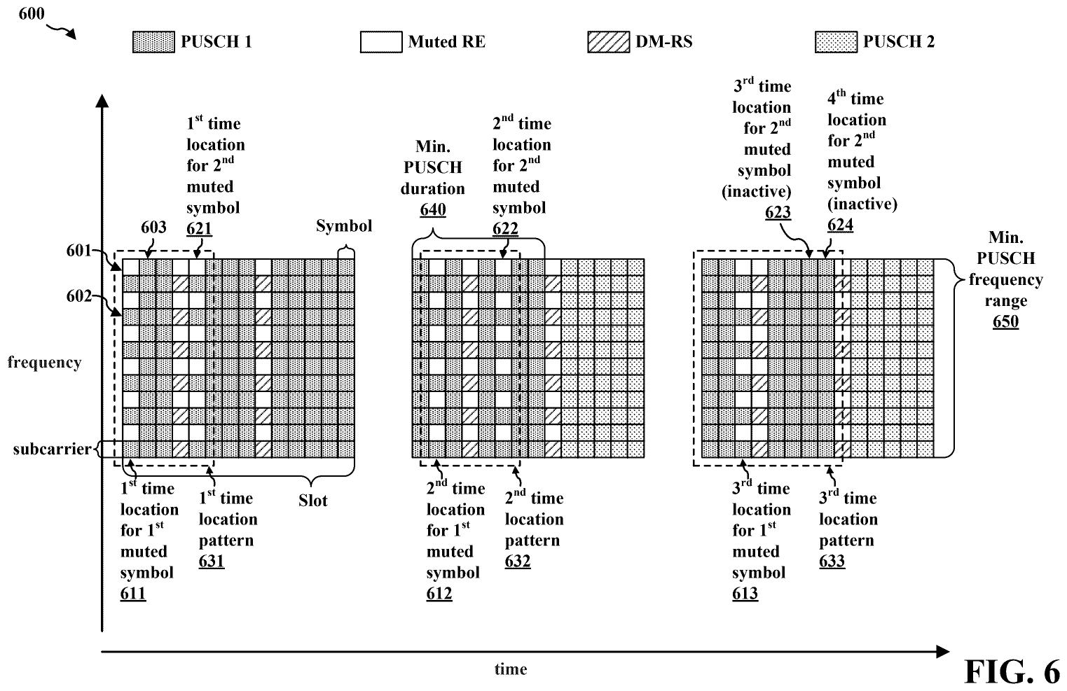

FIG. 6 is a diagram 600 illustrating different time locations for a first and second symbol that may be configured for UL resource muting in accordance with some aspects of the disclosure. In some aspects, the UL resource muting may be associated with a first PUSCH (or PUSCH transmission) and a single slot may include more than one PUSCH transmission. A muted symbol may include a first set of muted or zero-power REs (e.g., RE 601) and a second set of unmuted REs (e.g., RE 602) associated with a data transmission while an unmuted symbol 603 may include no muted REs. In some aspects, the UE may perform, or the second set of REs may be associated with, a rate matching around the muted REs. The muted REs, in some aspects and as illustrated in FIG. 6, may not overlap with DM-RS and/or PT-RS, e.g., in a same symbol. In some aspects, the second set of unmuted symbols may be subject to power boosting (e.g., may be power boosted) such that the total transmitted power of the PUSCH does not change across muted and unmuted symbols. The UL resource muting, in some aspects, may be applied to PUSCH transmissions with a minimum frequency domain allocation (e.g., minimum PUSCH frequency range 650 or a minimum number of RBs of subcarriers) and/or with a minimum time domain allocation (e.g., minimum PUSCH duration 640 or a minimum number of symbols).

The symbols associated with UL resource muting (e.g., the symbols within a slot to which the UL resource muting is applied), in some aspects, may be based on an indication and/or activation of one or more candidate time location configurations. In some aspects, each candidate time location configuration may indicate, specify, define, or be associated with, a candidate time location for one of (1) a first muted symbol of up to two muted symbols per slot, (2) a second muted symbol of the up to two muted symbols per slot, or (3) up to two muted symbols (e.g., both the first and second muted symbol) in the slot (e.g., the candidate time location configuration may be a candidate time location pattern configuration). The UL resource muting, in some aspects, may be associated with a comb-2 (e.g., a pattern of muted REs associated with muting every other RE in the frequency domain for the symbol) or other configured and/or known pattern. In some aspects, the candidate time location configurations may be resources and/or resource sets configured for other purposes (e.g., SRS resources and/or resource sets) that may be indicated as resources and/or resource sets for, or associated with, UL resource muting.

For a first example slot, UL resource muting may be applied to a first symbol and a fifth symbol of the slot. The first symbol of the slot may be muted based on a first time location configuration 611 for the first muted symbol (of the up to two muted symbols per slot) that indicates that the first symbol of the slot is to be muted (e.g., that the first symbol is the position and/or time location of the first muted symbol of the up to two muted symbols). For example, the first time location configuration 611 may be a candidate time location configuration indicating, specifying, defining, or associated with, a candidate time location for the first muted symbol of the up to two muted symbols per slot. Similarly, the fifth symbol of the slot may be muted based on a first time location configuration 621 for the second muted symbol (of the up to two muted symbols per slot) that indicates that the fifth symbol of the slot is to be muted (e.g., that the fifth symbol is the time location of the second muted symbol of the up to two muted symbols). In some aspects, the position of the first and second muted symbols may be based on a first time location pattern configuration 631 that indicates that UL resource muting on the first and fifth symbol of the slot. For example, the first time location pattern configuration 631 may be a candidate time location configuration (or candidate time location pattern configuration) indicating, specifying, defining, or associated with, a candidate time location for both the first and second muted symbol in the slot.

For a second example slot, UL resource muting may be applied to a second symbol and a sixth symbol of the slot. The second symbol of the slot may be muted based on a second (candidate) time location configuration 612 for the first muted symbol (of the up to two muted symbols per slot) that indicates that the second symbol of the slot is to be muted (e.g., that the second symbol is the time location of the first muted symbol of the up to two muted symbols). Similarly, the sixth symbol of the slot may be muted based on a second (candidate) time location configuration 622 for the second muted symbol (of the up to two muted symbols per slot) that indicates that the sixth symbol of the slot is to be muted (e.g., that the sixth symbol is the time location of the second muted symbol of the up to two muted symbols). In some aspects, the position of the first and second muted symbols may be based on a second (candidate) time location pattern configuration 632 that indicates that UL resource muting on the second and sixth symbol of the slot.

For a third example slot, UL resource muting may be applied to a third symbol of the slot. The third symbol of the slot may be muted based on a third (candidate) time location configuration 613 for the first muted symbol (of the up to two muted symbols per slot) that indicates that the third symbol of the slot is to be muted (e.g., that the third symbol is the time location of the first muted symbol of the up to two muted symbols). The UL resource muting for the third example slot, in some aspects, may not be associated with a second muted symbol. In some aspects, the second muted symbol may be associated with one or more additional inactive (candidate) time location configurations (e.g., a third (candidate) time location configuration 623 for the second slot or a fourth (candidate) time location configuration 624 for the second slot) that indicate that the seventh (or eighth) symbol of the slot is to be muted (e.g., that the seventh or eighth symbol is the time location of the second muted symbol of the up to two muted symbols). In some aspects, the position of the first muted symbol may be based on a third (candidate) time location pattern configuration 633 that indicates that UL resource muting on the third symbol of the slot without indicating a second muted symbol. In the discussion above, the (candidate) time location configurations and/or (candidate) time location pattern configurations may be identified by reference to resources and/or resource sets configured for other purposes (e.g., SRS) that may be additionally used to identify resources for UL resource muting based on a UE capability.

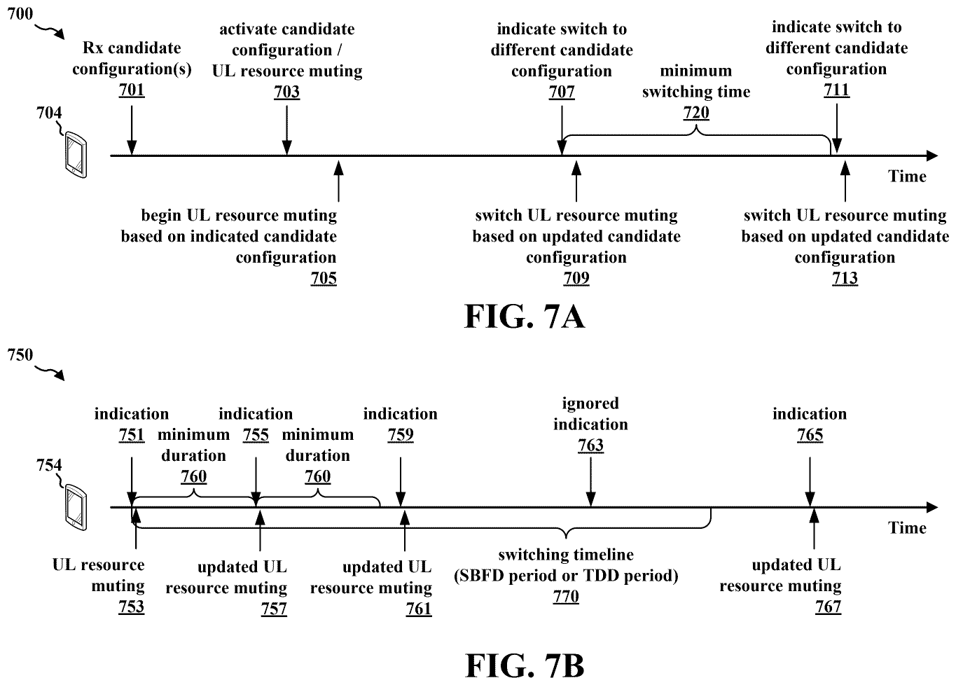

FIG. 7A is a diagram 700 illustrating a first timeline associated with UL resource muting in accordance with some aspects of the disclosure. Diagram 700 illustrates that, at 701, a UE 704 may receive at least one UL resource muting configuration(s) (e.g., including one or more candidate time location configurations and additional parameters associated with the UL resource muting). In some aspects, the UE 704 may have previously transmitted an indication of support for different features of UL resource muting (or UE capability indication) and the at least one UL resource muting configuration(s) received at 701 may be based on the indication of support. The at least one UL resource muting configuration(s), in some aspects, may be received via RRC signaling or via a MAC-CE. The UE 704 may subsequently, at 703, receive an indication to activate UL resource muting and/or an indication of a particular candidate UL resource muting time location configuration included in the at least one UL resource muting configuration(s) to use for UL resource muting. In some aspects, the indication to activate UL resource muting (e.g., an UL resource muting activation indication) may be associated with a single received UL resource muting time location configuration (e.g., a time location configuration for UL resource muting) or a most recent UL resource muting time location configuration (e.g., a last used time location configuration for UL resource muting) that may be either activated or deactivated (e.g., inactive, unactivated, disabled, etc.). In some aspects, the indication of the particular candidate UL resource muting time location configuration included in the at least one UL resource muting configuration(s) to use for UL resource muting may also be interpreted as an activation of UL resource muting based on the indicated particular candidate UL resource muting time location configuration. The indication of the particular candidate UL resource muting time location configuration, in some aspects, may be received via one of a MAC-CE or via DCI.

Based on the indication(s) received at 703, the UE 704 may, at 705, begin UL resource muting based on the indicated (candidate) UL resource muting time location configuration (e.g., the single, current, or particular UL resource muting time location configuration). The UE 704 may subsequently receive, at 707, an indication to switch to a different candidate UL resource muting time location configuration included in the at least one UL resource muting configuration(s) to use for UL resource muting. Based on the indication received at 707, the UE 704 may, at 709, switch to using the indicated different candidate UL resource muting time location configuration. In some aspects, there may be a minimum wait time (e.g., minimum switching time 720) between indications to switch to a different UL resource muting time location configurations that the UE 704 supports. Accordingly, the UE 704 may subsequently receive, at 711 and after the minimum switching time 720 has elapsed, an indication to switch to a different candidate UL resource muting time location configuration included in the at least one UL resource muting configuration(s) to use for UL resource muting. Based on the indication received at 711, the UE 704 may, at 713, switch to using the indicated different candidate UL resource muting time location configuration. In some aspects, the minimum wait time may be indicated in the previously transmitted indication of support for different features of UL resource muting (or the UE capability indication).

FIG. 7B is a diagram 750 illustrating a second timeline associated with switching between different UL resource muting time location configurations in accordance with some aspects of the disclosure. As described in relation to FIG. 7A, the UE 754 may transmit an indication of a minimum wait time (e.g., minimum switching time 720) between indications to switch to a different UL resource muting time location configurations that the UE 754 supports. In some aspects, the UE may indicate a maximum number of switches (e.g., two or three switches) between different UL resource muting time location configurations (e.g., different UL resource muting configurations indicating different symbol positions, or time locations, for one or more of the up to two UL muting symbols within a slot) that the UE can support. The maximum number of switches between different UL resource muting time location configurations that the UE supports may be specified for a particular duration and/or time period, e.g., a first period associated with SBFD (a configured SBFD period), a second period associated with TDD (a period associated with a TDD slot format pattern), or a duration based on, or indicated as, a number (n) of slots or milliseconds.

In diagram 750, the particular duration and/or time period may be indicated to be switching timeline 770 and the maximum number of switches may be indicated to be two or three switches (two switches if not counting/including the initial switch at 753 based on the indication received at 751 or three switches if the initial switch at 753 based on the indication received at 751 is counted/included). Accordingly, based on receiving, at 755 and 759, indications to switch and switching, at 757 and 761, between different UL resource muting time location configurations, an additional indication received at 763 during the switching timeline 770 may be ignored, and the UE 754 may continue to use a current UL resource muting time location configuration (associated with the indication received at 759), based on having reached the maximum number of switches supported by the UE. After the switching timeline 770 expires, the UE 754 may, at 765, receive an indication to switch between different UL resource muting time location configurations and perform UL resource muting, at 767, based on the new, updated and/or different UL resource muting configuration indicated at 765. In some aspects, a base station may, based on the known maximum number of switches, refrain from transmitting the additional indication exceeding the maximum number of switches.

In addition to the maximum number of switches, the UE may indicate a minimum duration (e.g., minimum duration 760) associated with a switch to a particular UL resource muting time location configuration. The minimum duration, in some aspects, may be a duration that the UE maintains the particular UL resource muting time location configuration (e.g., the position, or pattern, of the symbol(s) associated with the particular UL resource muting time location configuration) before it may switch to a subsequently indicated new, updated and/or different UL resource muting configuration. The duration that the UE maintains the particular UL resource muting time location configuration may be specified as one of a number (n) of slots, a number (m) milliseconds, a first period associated with SBFD (a configured SBFD period), a second period associated with TDD (a period associated with a TDD slot format pattern).

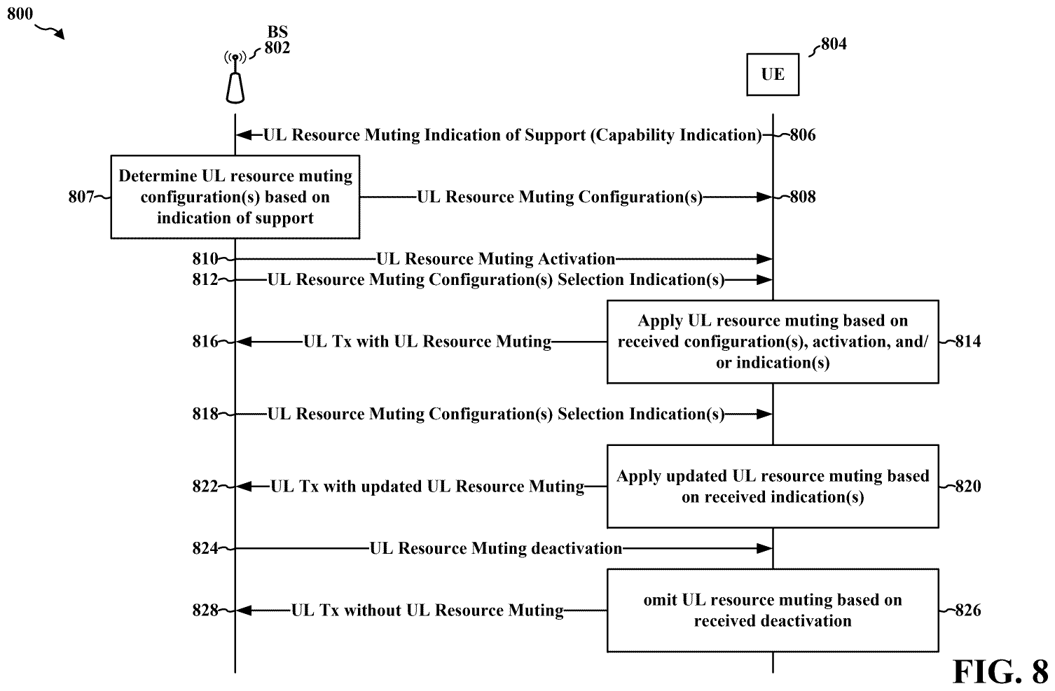

FIG. 8 is a call flow diagram 800 illustrating a method of wireless communication in accordance with some aspects of the disclosure. The method is illustrated in relation to a base station 802 (e.g., as an example of a network device or network node that may include one or more components of a disaggregated base station) in communication with a UE 804 (e.g., as an example of a wireless device). The functions ascribed to the base station 802, in some aspects, may be performed by one or more components of a network entity, a network node, or a network device (a single network entity/node/device or a disaggregated network entity/node/device as described above in relation to FIG. 1). Similarly, the functions ascribed to the UE 804, in some aspects, may be performed by one or more components of a wireless device supporting communication with a network entity/node/device. Accordingly, references to “transmitting” in the description below may be understood to refer to a first component of the base station 802 (or the UE 804) outputting (or providing) an indication of the content of the transmission to be transmitted by a different component of the base station 802 (or the UE 804). Similarly, references to “receiving” in the description below may be understood to refer to a first component of the base station 802 (or the UE 804) receiving a transmitted signal and outputting (or providing) the received signal (or information based on the received signal) to a different component of the base station 802 (or the UE 804).

The UE 804 may transmit, and the base station 802 may receive, an indication 806 (e.g., a UE capability indication) indicating whether the UE 804 supports UL resource muting. In some aspects, the indication may be for a particular feature associated with UL resource muting. The UE may indicate that the UE supports one or more features associated with UL resource muting. The UE may indicate that the UE does not support one or more features associated with UL resource muting. The indication 806 may be associated with one or more of (1) UL resource muting activation, (2) a number of UL resource muting time location configurations supported by the UE, (3) UL resource muting time location configuration switching, (4) a use of ZP SRS resources (or ZP SRS resource sets) for the UL resource muting, (5) one or more UL waveforms (e.g., waveforms that may have UL resource muting applied), (6) one or more transmission types (e.g., transmission types that may have UL resource muting applied), (7) a maximum number of muted symbols in a time window, (8) a slot type (e.g., one or more slot types that may have UL resource muting applied), (9) power boosting of unmuted PUSCH resources (e.g., power boosting of unmuted REs in a muted symbol in association with the UL resource muting), (10) a minimum frequency domain allocation of, or for, a PUSCH to which the UL resource muting may be applied, or (11) a minimum time domain allocation of, or for, a PUSCH to which the UL resource muting may be applied.

In some aspects, the indication 806 may indicate the support for (or that the UE does not support) the UL resource muting associated with the UL resource muting activation, and the indication 806 may indicate support for (e.g., whether the UE supports) one or more of a dynamic activation and a dynamic deactivation of the UL resource muting. The indication 806, in some aspects, may indicate the support for the UL resource muting associated with the UL resource muting activation, and the indication 806 may indicate support for one or more of a dynamic indication and/or activation of a candidate UL resource muting time location configuration.

As will be explained in relation to the at least one configuration(s) 808 below, the UE 804 may receive a set of candidate UL resource muting time location configurations (e.g., UL resource muting time location configurations that may be activated and/or selected). The set of candidate UL resource muting time location configurations, in some aspects, may be associated with one or more of: (1) a first position and/or time location within a slot of a first muted symbol for the UL resource muting, (2) a second position and/or time location within the slot of the first muted symbol for the UL resource muting, (3) a third position and/or time location within the slot of a second muted symbol for the UL resource muting, or (4) a fourth position and/or time location within the slot of a second muted symbol for the UL resource muting. In some aspects, each candidate UL resource muting time location configuration in the set of candidate UL resource muting time location configurations may be associated with, indicate, or specify, one or more of: (1) a (first and/or corresponding) position and/or time location within a slot of a first muted symbol for the UL resource muting or (2) a (second and/or corresponding) position and/or time location within the slot of a second muted symbol for the UL resource muting.

The indication 806, in some aspects, may indicate the support for (or that the UE does not support) the UL resource muting associated with the number of UL resource muting time location configurations supported by the UE, each candidate UL resource muting time location configuration in the set of candidate UL resource muting time location configurations may be associated with one of the first muted symbol, the second muted symbol, or a pattern associated with the first muted symbol and the second muted symbol for the UL resource muting, and the indication 806 may indicate support for (e.g., whether the UE supports UL resource muting for) one or more of (1) a first maximum number of candidate UL resource muting time location configurations associated with the first muted symbol (or the position and/or time location of the first muted symbol) for the UL resource muting and a second maximum number of candidate UL resource muting time location configurations associated with the second muted symbol (or the position and/or time location of the second muted symbol) for the UL resource muting (where the first maximum number and the second maximum number may be the same or may be different), or (2) a third maximum number of candidate UL resource muting time location configurations associated with a pattern associated with the first muted symbol and the second muted symbol (e.g., a pattern including the position and/or time location of the first muted symbol for the UL resource muting and/or the position and/or time location of the second muted symbol) for the UL resource muting.

In some aspects, the UE 804 may support (or may not support) multiple candidate UL resource muting time location configurations. The indication 806, in some aspects, may indicate the support for the UL resource muting associated with the UL resource muting time location configuration switching, and the indication 806 may indicate support for (e.g., whether the UE supports UL resource muting for) one or more of (1) a first maximum number of switches between different candidate UL resource muting time location configurations in the plurality of candidate UL resource muting time location configurations, (2) a second maximum number of switches between the different candidate UL resource muting time location configurations during a first duration, where the first duration is one of a first period associated with an SBFD configuration period (or a configured SBFD period), a second period associated with a TDD slot format pattern, a first number of slots, or a second number of milliseconds, or (3) a minimum time between switches between the different candidate UL resource muting time location configurations, where the minimum time is one of a third number slots or a fourth number of milliseconds.

The UE 804, in some aspects, may support (or may not support) multiple candidate UL resource muting time location configurations where the candidate UL resource muting time location configurations may be candidate SRS resource configurations (e.g., a SRS resource or SRS resource set may be used to identify the UL resource muting time location configurations and/or UL resources to be muted in association with the UL resource muting). In some aspects, each candidate SRS resource configuration in the set of candidate UL resource muting time location configurations may be associated with one of the first muted symbol, the second muted symbol, or a pattern associated with the first muted symbol and the second muted symbol for the UL resource muting. The indication 806, in some aspects, may indicate the support for the UL resource muting associated with the use of ZP SRS resources for the UL resource muting, and the indication may indicate support for (e.g., whether the UE supports UL resource muting for) one or more of: (1) a first maximum number of candidate SRS resource configurations associated with the first muted symbol (or the position and/or time location of the first muted symbol) for the UL resource muting and a second maximum number of candidate SRS resource configurations associated with the second muted symbol (or the position and/or time location of the second muted symbol) for the UL resource muting, (2) a third maximum number of candidate SRS resource configurations associated with a pattern associated with the first muted symbol and the second muted symbol (e.g., a pattern including the position and/or time location of the first muted symbol for the UL resource muting and/or the position and/or time location of the second muted symbol) for the UL resource muting, (3) a fourth maximum number of switches between different candidate SRS resource configurations, (4) a fifth maximum number of switches between the different candidate SRS resource configurations during a first duration, wherein the first duration is one of a first period associated with an SBFD configuration period (or a configured SBFD period), a second period associated with a TDD slot format pattern, a first number of slots, or a second number of milliseconds, or (5) a minimum time between switches between the different candidate SRS resource configurations, where the minimum time is one of a third number slots or a fourth number of milliseconds.

In some aspects, the indication 806 may indicate the support for (or that the UE does not support) the UL resource muting associated with the one or more UL waveforms, and the indication 806 may indicate support for (e.g., whether the UE supports UL resource muting for) one or more of: (1) the UL resource muting associated with a DFT-s-OFDM waveform for UL, (2) the UL resource muting associated with a CP-OFDM waveform for UL, (3) a same UL resource muting configuration for the DFT-s-OFDM waveform and the CP-OFDM waveform, or (4) different UL resource muting configurations for the DFT-s-OFDM waveform and the CP-OFDM waveform.

The indication 806, in some aspects, may indicate the support for (or that the UE does not support) the UL resource muting associated with the one or more transmission types, and wherein the indication indicates support for (e.g., whether the UE supports UL resource muting for) one or more of: (1) the UL resource muting for a configured grant (CG) PUSCH, (2) the UL resource muting for a dynamic grant PUSCH, (3) the UL resource muting for a transport block processing over multi-slot (TBoMS) PUSCH, (4) the UL resource muting for a first PUSCH associated with one or more of a first type of repetition (e.g., a Type A repetition) or a second type of the repetition (e.g., a Type B repetition), (5) the UL resource muting for a second PUSCH with intra-slot frequency hopping, (6) the UL resource muting for a third PUSCH with inter-slot frequency hopping, or (7) the UL resource muting for a fourth PUSCH associated with one or more of a first type of resource mapping (e.g., a Type A resource mapping) or a second type of the resource mapping (e.g., a Type B resource mapping).

In some aspects, the indication 806 may indicate the support for (or that the UE does not support) the UL resource muting associated with the maximum number of muted symbols in the time window, and the indication 806 may indicate support for (e.g., whether the UE supports UL resource muting for) one or more of: (1) a first maximum number of muted symbols within the slot or (2) a second maximum number of muted symbols within a mini-slot.

The indication 806, in some aspects, may indicate the support for (or that the UE does not support) the UL resource muting associated with the slot type, and the indication 806 may indicate support for (e.g., whether the UE supports UL resource muting for) one or more of: (1) the UL resource muting on SBFD symbols, (2) the UL resource muting on non-SBFD symbols, (3) a same UL resource muting configuration for the SBFD symbols and the non-SBFD symbols, or (4) different UL resource muting configurations for the SBFD symbols and the non-SBFD symbols.

In some aspects, the indication 806 may indicate the support for (or that the UE does not support) the UL resource muting associated with the power boosting of the unmuted PUSCH resources, and the indication 806 may indicate that (or whether) the UE supports the power boosting on the unmuted PUSCH resources transmitted in a first symbol during which the UL resource muting is applied (e.g., supports power boosting for unmuted REs used to transmit the PUSCH transmission in a muted symbol). Based on the power boosting of the unmuted PUSCH resources, in some aspects, the power may not change across the symbols of the PUSCH transmission (e.g., across unmuted symbols and muted symbols) such that a first transmitted power associated with the first symbol and a second transmitted power associated with a second symbol during which the UL resource muting is not applied are a same power (where a same power may refer to being within a power difference threshold that is less than 3 dB, less than 1 dB or some other threshold value configured for the power boosting).

The indication 806, in some aspects, may indicate the support for (or that the UE does not support) the UL resource muting associated with the minimum frequency domain allocation of the PUSCH to which the UL resource muting may be applied, and the indication 806 may indicate a minimum number of frequency resources associated with (or allocated to or for) a PUSCH for which the UE supports the UL resource muting. In some aspects, the frequency resources may be one of resource blocks or sub-carriers. Accordingly, the UE 804 may not support UL resource muting for an UL transmission allocated fewer than the minimum number of frequency resources (e.g., the UE 804 may not be capable of applying UL resource muting to an UL transmission spanning a frequency range that is smaller than the minimum number of frequency resources).

In some aspects, the indication 806 may indicate the support for (or that the UE does not support) the UL resource muting associated with the minimum time domain allocation of the PUSCH to which the UL resource muting may be applied, and the indication 806 may indicate a minimum number of time-domain resources associated with (or allocated to or for) a PUSCH for which the UE supports the UL resource muting. The time-domain resources, in some aspects, may be one of slots, symbols, or milliseconds. Accordingly, the UE 804 may not support UL resource muting for an UL transmission allocated fewer than the minimum number of time domain resources (e.g., the UE 804 may not be capable of applying UL resource muting to an UL transmission spanning a time and/or duration that is smaller than the minimum number of time domain resources).

At 807, the base station 802 may determine, based on the indication 806 (e.g., based on the indicated support for, or a UE capability associated with, the different aspects of UL resource muting) at least one UL resource muting configuration supported by the UE 804. In some aspects, the at least one UL resource muting configuration may be, or include, a set of candidate UL resource muting time location configurations (e.g., UL resource muting time location configurations that may be activated and/or selected). The set of candidate UL resource muting time location configurations, in some aspects, may be associated with one or more of: (1) a first position within a slot of a first muted symbol for the UL resource muting, (2) a second position within the slot of the first muted symbol for the UL resource muting, (3) a third position within the slot of a second muted symbol for the UL resource muting, or (4) a fourth position within the slot of a second muted symbol for the UL resource muting. In some aspects, each candidate UL resource muting time location configuration in the set of candidate UL resource muting time location configurations may be associated with, indicate, or specify, one or more of: (1) a (first and/or corresponding) position within a slot of a first muted symbol for the UL resource muting or (2) a (second and/or corresponding) position within the slot of a second muted symbol for the UL resource muting.

For example, a first subset of the candidate UL resource muting time location configurations (e.g., first time location configuration 611, second time location configuration 612, and third time location configuration 613 for the first muted symbol) may be associated with a first muted symbol and may correspond to, indicate, or specify, a different time location and/or position within the slot and/or mini-slot for the first muted symbol. Similarly, a second subset of the candidate UL resource muting time location configurations (e.g., first time location configuration 621, second time location configuration 622, third time location configuration 623, and fourth time location configuration 624 for the second muted symbol) may be associated with a second muted symbol and may correspond to, indicate, or specify, a different time location and/or position within the slot and/or mini-slot for the second muted symbol. Accordingly, each candidate UL resource muting time location configuration in the set of candidate UL resource muting time location configurations may indicate and/or correspond to a different time location and/or position within the slot. In some aspects, each candidate UL resource muting time location configuration in the set of candidate UL resource muting time location configurations may be a candidate UL resource muting time location pattern configuration associated with a pattern of up to two muted symbols in a slot and/or mini-slot (e.g., may be one of the first time location pattern configuration 631, the second time location pattern configuration 632, or the third time location pattern configuration 633 associated with a candidate time location for one, or both, of the first and second muted symbol in the slot).

The at least one UL resource muting configuration, in some aspects, may include and/or be associated with additional parameters for the UL resource muting based on the aspects of the UL resource muting indicated to be supported by the indication 806 (e.g., as a UE capability indication). Based on the determination at 807, the base station 802 may transmit, and the UE 804 may receive, the at least one UL resource muting configuration(s) 808. In some aspects, the at least one UL resource muting configuration(s) 808 may be transmitted and/or received via RRC signaling or MAC-CE.

Based on the at least one UL resource muting configuration(s) 808, the base station 802 may subsequently transmit, and the UE 804 may receive one or more of a UL resource muting activation indication 810 and a UL resource muting configuration selection indication 812. The UL resource muting activation indication 810 and the UL resource muting configuration selection indication 812, in some aspects, may be transmitted and/or received via a MAC-CE and/or DCI. In some aspects, the UL resource muting activation indication 810 may activate the UL resource muting and the UL resource muting configuration selection indication 812 may indicate a selected candidate UL resource muting time location configuration for an UL resource muting associated with a subsequent UL transmission. The UL resource muting activation indication 810, in some aspects, may, in the absence of the UL resource muting configuration selection indication 812 (or other indication of a particular UL resource muting time location configuration to use for the UL resource muting), indicate one of a single, current, or default UL resource muting time location configuration included in the at least one UL resource muting configuration(s) 808. The selected candidate UL resource muting time location configuration may be selected from a plurality of candidate UL resource muting time location configurations included in the at least one UL resource muting configuration(s) 808. In some aspects, in the absence of the UL resource muting activation indication 810, the UL resource muting configuration selection indication 812 may both activate the UL resource muting and indicate a particular UL resource muting configuration (e.g., a candidate UL resource muting time location configuration) to use for the UL resource muting.

Based on the UL resource muting activation indication 810 and/or the UL resource muting configuration selection indication 812, the UE 804 may, at 814, apply the UL resource muting to a UL transmission 816. Applying the UL resource muting at 814, in some aspects, may include muting the resources indicated by the selected and/or indicated candidate UL resource muting time location configuration(s) (e.g., a single selected and/or indicated candidate UL resource muting time location pattern configuration indicating a location for up to two muted symbols in a slot, or a pair of selected and/or indicated candidate UL resource muting time location configurations each indicating a location for one of the up to two muted symbols in a slot). The UE 804 may transmit, and the base station 802 may receive, the UL transmission 816 to which the UL resource muting has been applied at 814. In some aspects, based on the knowledge of the UL resources muted by the UE 804 (e.g., the UL resources for muting by the UE 804 configured, activated, and/or selected by the base station 802), the base station 802 may perform a CLI measurement over the muted resources while receiving the UL transmission 816.

Based on the at least one UL resource muting configuration(s) 808, the base station 802 may subsequently transmit, and the UE 804 may receive an additional UL resource muting configuration selection indication 818. The additional UL resource muting configuration selection indication 818, in some aspects, may be transmitted and/or received via a MAC-CE and/or DCI. In some aspects, the additional UL resource muting configuration selection indication 818 may indicate a switch to a different and/or updated selected candidate UL resource muting time location configuration for an UL resource muting associated with a subsequent UL transmission. The different and/or updated selected candidate UL resource muting time location configuration may be selected from the plurality of candidate UL resource muting time location configurations included in the at least one UL resource muting configuration(s) 808. In some aspects, the timing of the additional UL resource muting configuration selection indication 818 may be based on or limited by one of a minimum time between using different UL resource muting time location configurations or a minimum duration for applying a particular UL resource muting time location configuration as discussed in relation to FIGS. 7A and 7B.

Based on the additional UL resource muting configuration selection indication 818, the UE 804 may, at 820, apply the UL resource muting to a UL transmission 822. Applying the UL resource muting at 820, in some aspects, may include muting the resources indicated by the selected and/or indicated candidate UL resource muting time location configuration(s) the additional UL resource muting configuration selection indication 818 (e.g., a single selected and/or indicated candidate UL resource muting time location pattern configuration indicating a location for up to two muted symbols in a slot, or a pair of selected and/or indicated candidate UL resource muting time location configurations each indicating a location for one of the up to two muted symbols in a slot). The UE 804 may transmit, and the base station 802 may receive, the UL transmission 822 to which the UL resource muting has been applied at 820. In some aspects, based on the knowledge of the UL resources muted by the UE 804 (e.g., the UL resources for muting by the UE 804 configured, activated, and/or selected by the base station 802), the base station 802 may perform a CLI measurement over the muted resources while receiving the UL transmission 822.

The base station 802, in some aspects, may transmit and the UE 804 may receive, a (dynamic) UL resource muting deactivation 824 deactivating the UL resource muting for subsequent UL transmissions. Based on receiving the UL resource muting deactivation 824, the UE 804 may, at 826, omit the UL resource muting for an UL transmission 828. The UE 804 may transmit, and the base station 802 may receive, the UL transmission 828 for which UL resource muting has been omitted at 826. In some aspects, based on the knowledge that the UL resources are unmuted by the UE 804 (e.g., that the UL resource muting has been deactivated by the base station 802), the base station 802 may not perform a CLI measurement over the resources associated with receiving the UL transmission 828.

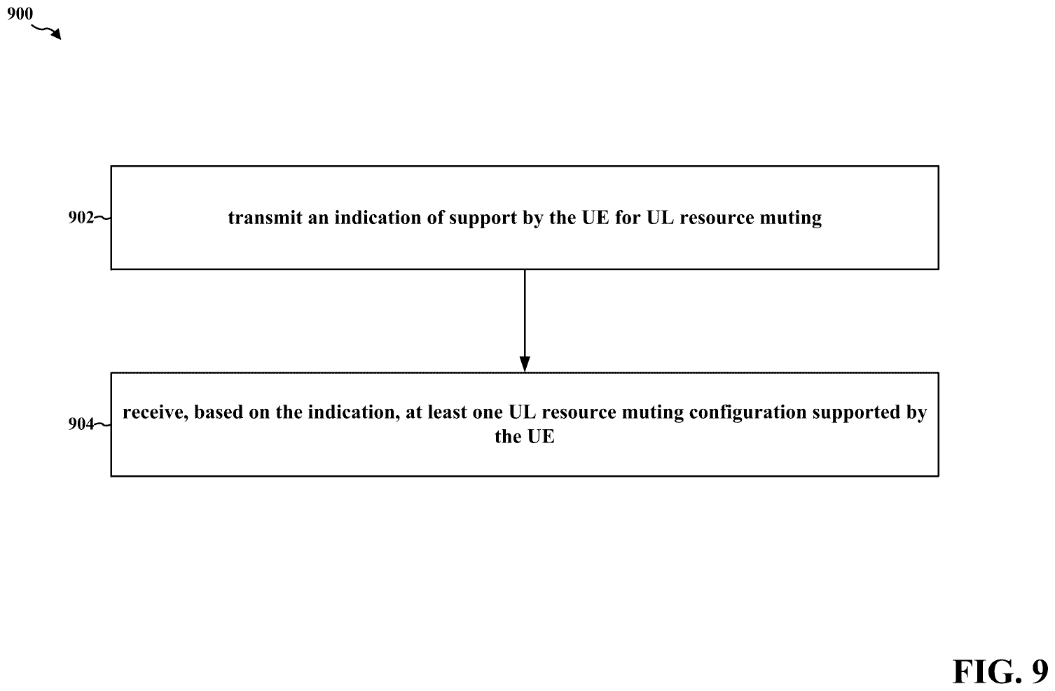

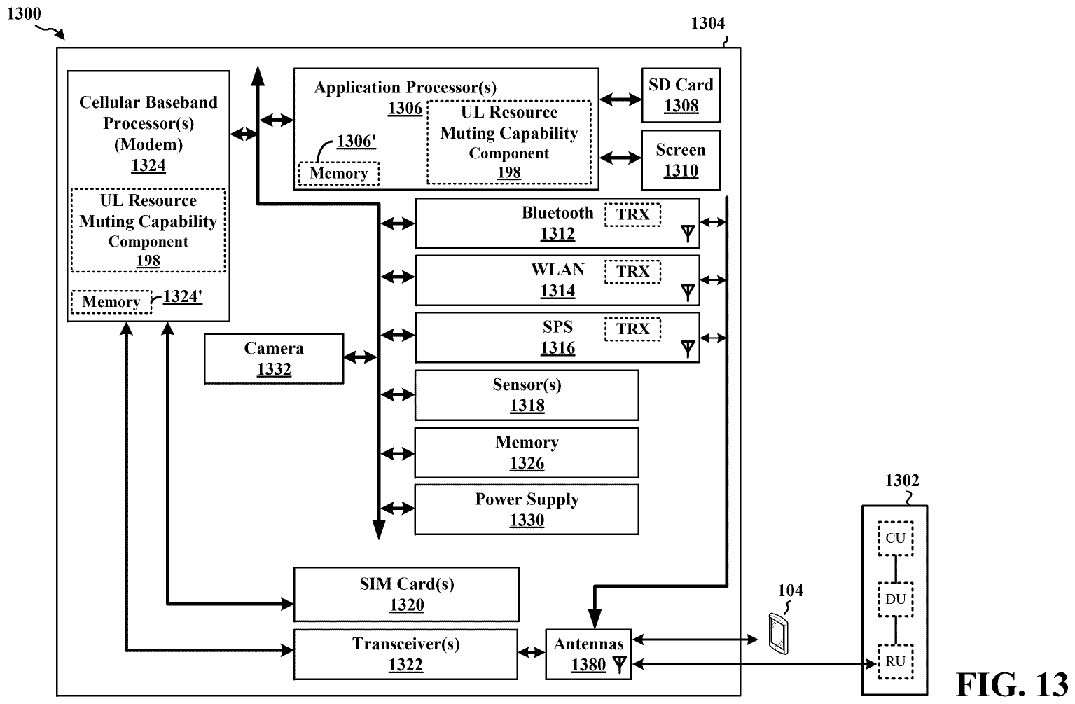

FIG. 9 is a flowchart 900 of a method of wireless communication. The method may be performed by a wireless device such as a UE (e.g., the UE 104, 704, 754, 804; the apparatus 1304). At 902, the UE may transmit an indication of support by the UE for UL resource muting. The indication of support, in some aspects, may be a UE capability indication. For example, 902 may be performed by application processor(s) 1306, cellular baseband processor(s) 1324, transceiver(s) 1322, antenna(s) 1380, and/or UL resource muting capability component 198 of FIG. 13. The indication of support by the UE for the UL resource muting may be associated with one or more of (1) UL resource muting activation, (2) a number of UL resource muting time location configurations supported by the UE, (3) UL resource muting time location configuration switching, (4) a use of ZP SRS resources (or ZP SRS resource sets) for the UL resource muting, (5) one or more UL waveforms (e.g., waveforms that may have UL resource muting applied), (6) one or more transmission types (e.g., transmission types that may have UL resource muting applied), (7) a maximum number of muted symbols in a time window, (8) a slot type (e.g., one or more slot types that may have UL resource muting applied), (9) power boosting of unmuted PUSCH resources (e.g., power boosting of unmuted REs in a muted symbol in association with the UL resource muting), (10) a minimum frequency domain allocation of, or for, a PUSCH to which the UL resource muting may be applied, or (11) a minimum time domain allocation of, or for, a PUSCH to which the UL resource muting may be applied. For example, referring to FIG. 8, the UE 804 may transmit, and the base station 802 may receive, the indication 806 (e.g., a UE capability indication) indicating support by the UE 804 for UL resource muting.

As will be explained in relation to the at least one UL resource muting configuration supported by the UE received at 904, the UE may receive at least one UL resource muting configuration that may include a set of candidate UL resource muting time location configurations (e.g., UL resource muting time location configurations that may be activated and/or selected). The set of candidate UL resource muting time location configurations, in some aspects, may be associated with one or more of: (1) a first position and/or time location within a slot of a first muted symbol for the UL resource muting, (2) a second position and/or time location within the slot of the first muted symbol for the UL resource muting, (3) a third position and/or time location within the slot of a second muted symbol for the UL resource muting, or (4) a fourth position and/or time location within the slot of a second muted symbol for the UL resource muting. In some aspects, each candidate UL resource muting time location configuration in the set of candidate UL resource muting time location configurations may be associated with, indicate, or specify, one or more of: (1) a (first and/or corresponding) position and/or time location within a slot of a first muted symbol for the UL resource muting or (2) a (second and/or corresponding) position and/or time location within the slot of a second muted symbol for the UL resource muting.

In some aspects, the indication of support may indicate the support for the UL resource muting associated with the UL resource muting activation, and the indication of support may indicate support for (e.g., whether the UE supports UL resource muting for) one or more of a dynamic activation and a dynamic deactivation of the UL resource muting. The indication of support, in some aspects, may indicate the support for the UL resource muting associated with the UL resource muting activation, and the indication of support may indicate support for one or more of a dynamic indication and/or activation of a candidate UL resource muting time location configuration.

The indication of support, in some aspects, may indicate the support for the UL resource muting associated with the number of UL resource muting time location configurations supported by the UE, each candidate UL resource muting time location configuration in the set of candidate UL resource muting time location configurations may be associated with one of the first muted symbol, the second muted symbol, or a pattern associated with the first muted symbol and the second muted symbol for the UL resource muting, and the indication 806 may indicate support for (e.g., whether the UE supports UL resource muting for) one or more of (1) a first maximum number of candidate UL resource muting time location configurations associated with the first muted symbol (or the position and/or time location of the first muted symbol) for the UL resource muting and a second maximum number of candidate UL resource muting time location configurations associated with the second muted symbol (or the position and/or time location of the second muted symbol) for the UL resource muting (where the first maximum number and the second maximum number may be the same or may be different), or (2) a third maximum number of candidate UL resource muting time location configurations associated with a pattern associated with the first muted symbol and the second muted symbol (e.g., a pattern including the position and/or time location of the first muted symbol for the UL resource muting and/or the position and/or time location of the second muted symbol) for the UL resource muting.

In some aspects, the UE may support multiple candidate UL resource muting time location configurations. The indication of support, in some aspects, may indicate the support for the UL resource muting associated with the UL resource muting time location configuration switching, and the indication of support may indicate support for (e.g., whether the UE supports UL resource muting for) one or more of (1) a first maximum number of switches between different candidate UL resource muting time location configurations in the plurality of candidate UL resource muting time location configurations, (2) a second maximum number of switches between the different candidate UL resource muting time location configurations during a first duration, where the first duration is one of a first period associated with an SBFD configuration period (or a configured SBFD period), a second period associated with a TDD slot format pattern, a first number of slots, or a second number of milliseconds, or (3) a minimum time between switches between the different candidate UL resource muting time location configurations, where the minimum time is one of a third number slots or a fourth number of milliseconds.

The UE, in some aspects, may support multiple candidate UL resource muting time location configurations where the candidate UL resource muting time location configurations may be candidate SRS resource configurations (e.g., a SRS resource or SRS resource set may be used to identify the UL resource muting time location configurations and/or UL resources to be muted in association with the UL resource muting). In some aspects, each candidate SRS resource configuration in the set of candidate UL resource muting time location configurations may be associated with one of the first muted symbol, the second muted symbol, or a pattern associated with the first muted symbol and the second muted symbol for the UL resource muting. The indication 806, in some aspects, may indicate the support for the UL resource muting associated with the use of ZP SRS resources for the UL resource muting, and the indication may indicate support for (e.g., whether the UE supports UL resource muting for) one or more of: (1) a first maximum number of candidate SRS resource configurations associated with the first muted symbol (or the position and/or time location of the first muted symbol) for the UL resource muting and a second maximum number of candidate SRS resource configurations associated with the second muted symbol (or the position and/or time location of the second muted symbol) for the UL resource muting, (2) a third maximum number of candidate SRS resource configurations associated with a pattern associated with the first muted symbol and the second muted symbol (e.g., a pattern including the position and/or time location of the first muted symbol for the UL resource muting and/or the position and/or time location of the second muted symbol) for the UL resource muting, (3) a fourth maximum number of switches between different candidate SRS resource configurations, (4) a fifth maximum number of switches between the different candidate SRS resource configurations during a first duration, wherein the first duration is one of a first period associated with an SBFD configuration period (or a configured SBFD period), a second period associated with a TDD slot format pattern, a first number of slots, or a second number of milliseconds, or (5) a minimum time between switches between the different candidate SRS resource configurations, where the minimum time is one of a third number slots or a fourth number of milliseconds.

In some aspects, the indication of support may indicate the support for the UL resource muting associated with the one or more UL waveforms, and the indication of support may indicate support for (e.g., whether the UE supports UL resource muting for) one or more of: (1) the UL resource muting associated with a DFT-s-OFDM waveform for UL, (2) the UL resource muting associated with a CP-OFDM waveform for UL, (3) a same UL resource muting configuration for the DFT-s-OFDM waveform and the CP-OFDM waveform, or (4) different UL resource muting configurations for the DFT-s-OFDM waveform and the CP-OFDM waveform.

The indication of support, in some aspects, may indicate the support for the UL resource muting associated with the one or more transmission types, and wherein the indication indicates support for (e.g., whether the UE supports UL resource muting for) one or more of: (1) the UL resource muting for a CG PUSCH, (2) the UL resource muting for a dynamic grant PUSCH, (3) the UL resource muting for a TBoMS PUSCH, (4) the UL resource muting for a first PUSCH associated with one or more of a first type of repetition (e.g., a Type A repetition) or a second type of the repetition (e.g., a Type B repetition), (5) the UL resource muting for a second PUSCH with intra-slot frequency hopping, (6) the UL resource muting for a third PUSCH with inter-slot frequency hopping, or (7) the UL resource muting for a fourth PUSCH associated with one or more of a first type of resource mapping (e.g., a Type A resource mapping) or a second type of the resource mapping (e.g., a Type B resource mapping).

In some aspects, the indication of support may indicate the support for the UL resource muting associated with the maximum number of muted symbols in the time window, and the indication of support may indicate support for (e.g., whether the UE supports UL resource muting for) one or more of: (1) a first maximum number of muted symbols within the slot or (2) a second maximum number of muted symbols within a mini-slot.

The indication of support, in some aspects, may indicate the support for the UL resource muting associated with the slot type, and the indication of support may indicate support for (e.g., whether the UE supports UL resource muting for) one or more of: (1) the UL resource muting on SBFD symbols, (2) the UL resource muting on non-SBFD symbols, (3) a same UL resource muting configuration for the SBFD symbols and the non-SBFD symbols, or (4) different UL resource muting configurations for the SBFD symbols and the non-SBFD symbols.

In some aspects, the indication of support may indicate the support for the UL resource muting associated with the power boosting of the unmuted PUSCH resources, and the indication of support may indicate that (or whether) the UE supports the power boosting on the unmuted PUSCH resources transmitted in a first symbol during which the UL resource muting is applied (e.g., supports power boosting for unmuted REs used to transmit the PUSCH transmission in a muted symbol). Based on the power boosting of the unmuted PUSCH resources, in some aspects, the power may not change across the symbols of the PUSCH transmission (e.g., across unmuted symbols and muted symbols) such that a first transmitted power associated with the first symbol and a second transmitted power associated with a second symbol during which the UL resource muting is not applied are a same power (where a same power may refer to being within a power difference threshold that is less than 3 dB, less than 1 dB or some other threshold value configured for the power boosting).

The indication of support, in some aspects, may indicate the support for the UL resource muting associated with the minimum frequency domain allocation of the PUSCH to which the UL resource muting may be applied, and the indication may indicate a minimum number of frequency resources associated with (or allocated to or for) a PUSCH for which the UE supports the UL resource muting. In some aspects, the frequency resources may be one of resource blocks or sub-carriers. Accordingly, the UE may not support UL resource muting for an UL transmission allocated fewer than the minimum number of frequency resources (e.g., the UE may not be capable of applying UL resource muting to an UL transmission spanning a frequency range that is smaller than the minimum number of frequency resources).

In some aspects, the indication of support may indicate the support for the UL resource muting associated with the minimum time domain allocation of the PUSCH to which the UL resource muting may be applied, and the indication may indicate a minimum number of time-domain resources associated with (or allocated to or for) a PUSCH for which the UE supports the UL resource muting. The time-domain resources, in some aspects, may be one of slots, symbols, or milliseconds. Accordingly, the UE may not support UL resource muting for an UL transmission allocated fewer than the minimum number of time domain resources (e.g., the UE may not be capable of applying UL resource muting to an UL transmission spanning a time and/or duration that is smaller than the minimum number of time domain resources).

At 904, the UE may, based on the indication, receive at least one UL resource muting configuration supported by the UE. For example, 904 may be performed by application processor(s) 1306, cellular baseband processor(s) 1324, transceiver(s) 1322, antenna(s) 1380, and/or UL resource muting capability component 198 of FIG. 13. In some aspects, the at least one UL resource muting configuration may be, or include, a set of candidate UL resource muting time location configurations (e.g., UL resource muting time location configurations that may be activated and/or selected). The set of candidate UL resource muting time location configurations, in some aspects, may be associated with one or more of: (1) a first position within a slot of a first muted symbol for the UL resource muting, (2) a second position within the slot of the first muted symbol for the UL resource muting, (3) a third position within the slot of a second muted symbol for the UL resource muting, or (4) a fourth position within the slot of a second muted symbol for the UL resource muting. In some aspects, each candidate UL resource muting time location configuration in the set of candidate UL resource muting time location configurations may be associated with, indicate, or specify, one or more of: (1) a (first and/or corresponding) position within a slot of a first muted symbol for the UL resource muting or (2) a (second and/or corresponding) position within the slot of a second muted symbol for the UL resource muting. In some aspects, the set of candidate UL resource muting time location configurations may include, or be, candidate SRS resource configurations (e.g., SRS resources or SRS resource sets previously defined for SRS transmission that may be selected for ZP SRS and/or UL resource muting). The at least one UL resource muting configuration, in some aspects, may include and/or be associated with additional parameters for the UL resource muting based on the aspects of the UL resource muting indicated to be supported by the indication transmitted at 902 (e.g., as a UE capability indication). For example, referring to FIG. 8, the base station 802 may transmit, and the UE 804 may receive, the at least one UL resource muting configuration(s) 808.

In some aspects, the UE may transmit an UL transmission with the UL resource muting based on an UL resource muting configuration from the at least one UL resource muting configuration. In some aspects, the UL resource muting configuration may include a UL resource muting time location configuration. For example, referring to FIG. 8, the UE 804 may, at 814, apply the UL resource muting to the UL transmission 816 and the UE 804 may transmit, and the base station 802 may receive, the UL transmission 816 to which the UL resource muting has been applied based on the at least one UL resource muting configuration(s) 808, the UL resource muting activation indication 810, and/or the UL resource muting configuration selection indication 812.

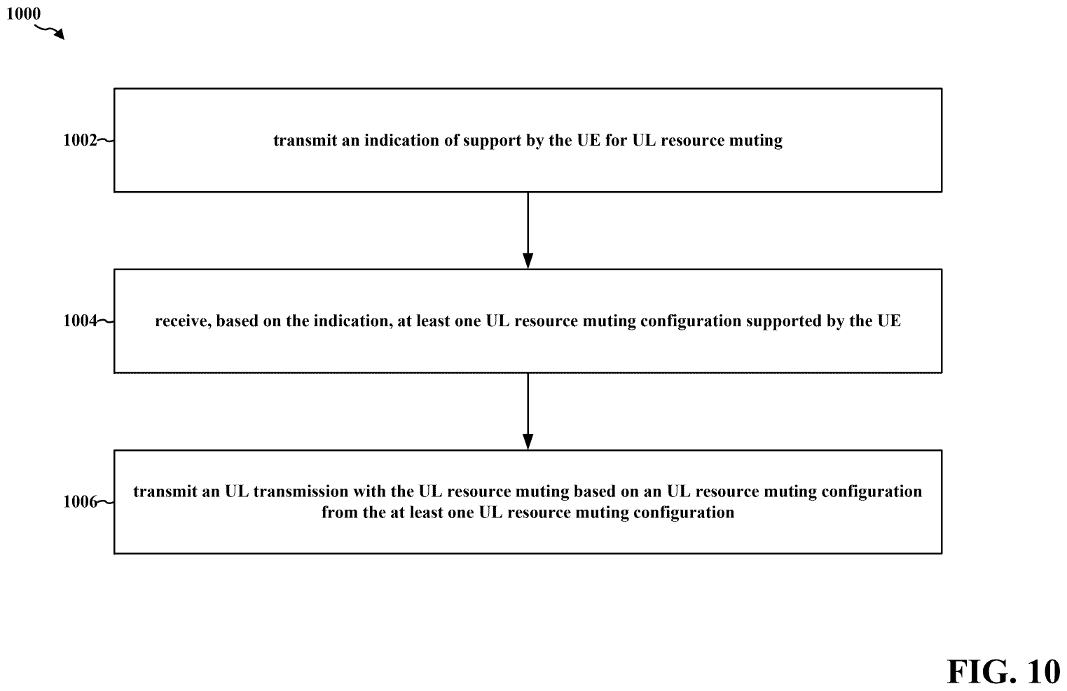

FIG. 10 is a flowchart 1000 of a method of wireless communication. The method may be performed by a wireless device such as a UE (e.g., the UE 104, 704, 754, 804; the apparatus 1304). At 1002, the UE may transmit an indication of support by the UE for UL resource muting. The indication of support, in some aspects, may be a UE capability indication. For example, 1002 may be performed by application processor(s) 1306, cellular baseband processor(s) 1324, transceiver(s) 1322, antenna(s) 1380, and/or UL resource muting capability component 198 of FIG. 13. The indication of support by the UE for the UL resource muting may be associated with one or more of (1) UL resource muting activation, (2) a number of UL resource muting time location configurations supported by the UE, (3) UL resource muting time location configuration switching, (4) a use of ZP SRS resources (or ZP SRS resource sets) for the UL resource muting, (5) one or more UL waveforms (e.g., waveforms that may have UL resource muting applied), (6) one or more transmission types (e.g., transmission types that may have UL resource muting applied), (7) a maximum number of muted symbols in a time window, (8) a slot type (e.g., one or more slot types that may have UL resource muting applied), (9) power boosting of unmuted PUSCH resources (e.g., power boosting of unmuted REs in a muted symbol in association with the UL resource muting), (10) a minimum frequency domain allocation of, or for, a PUSCH to which the UL resource muting may be applied, or (11) a minimum time domain allocation of, or for, a PUSCH to which the UL resource muting may be applied. For example, referring to FIG. 8, the UE 804 may transmit, and the base station 802 may receive, the indication 806 (e.g., a UE capability indication) indicating support by the UE 804 for UL resource muting.

As will be explained in relation to the at least one UL resource muting configuration supported by the UE received at 904, the UE may receive at least one UL resource muting configuration that may include a set of candidate UL resource muting time location configurations (e.g., UL resource muting time location configurations that may be activated and/or selected). The set of candidate UL resource muting time location configurations, in some aspects, may be associated with one or more of: (1) a first position and/or time location within a slot of a first muted symbol for the UL resource muting, (2) a second position and/or time location within the slot of the first muted symbol for the UL resource muting, (3) a third position and/or time location within the slot of a second muted symbol for the UL resource muting, or (4) a fourth position and/or time location within the slot of a second muted symbol for the UL resource muting. In some aspects, each candidate UL resource muting time location configuration in the set of candidate UL resource muting time location configurations may be associated with, indicate, or specify, one or more of: (1) a (first and/or corresponding) position and/or time location within a slot of a first muted symbol for the UL resource muting or (2) a (second and/or corresponding) position and/or time location within the slot of a second muted symbol for the UL resource muting.

In some aspects, the indication of support may indicate the support for the UL resource muting associated with the UL resource muting activation, and the indication of support may indicate support for (e.g., whether the UE supports UL resource muting for) one or more of a dynamic activation and a dynamic deactivation of the UL resource muting. The indication of support, in some aspects, may indicate the support for the UL resource muting associated with the UL resource muting activation, and the indication of support may indicate support for one or more of a dynamic indication and/or activation of a candidate UL resource muting time location configuration.

The indication of support, in some aspects, may indicate the support for the UL resource muting associated with the number of UL resource muting time location configurations supported by the UE, each candidate UL resource muting time location configuration in the set of candidate UL resource muting time location configurations may be associated with one of the first muted symbol, the second muted symbol, or a pattern associated with the first muted symbol and the second muted symbol for the UL resource muting, and the indication 806 may indicate support for (e.g., whether the UE supports UL resource muting for) one or more of (1) a first maximum number of candidate UL resource muting time location configurations associated with the first muted symbol (or the position and/or time location of the first muted symbol) for the UL resource muting and a second maximum number of candidate UL resource muting time location configurations associated with the second muted symbol (or the position and/or time location of the second muted symbol) for the UL resource muting (where the first maximum number and the second maximum number may be the same or may be different), or (2) a third maximum number of candidate UL resource muting time location configurations associated with a pattern associated with the first muted symbol and the second muted symbol (e.g., a pattern including the position and/or time location of the first muted symbol for the UL resource muting and/or the position and/or time location of the second muted symbol) for the UL resource muting.

In some aspects, the UE may support multiple candidate UL resource muting time location configurations. The indication of support, in some aspects, may indicate the support for the UL resource muting associated with the UL resource muting time location configuration switching, and the indication of support may indicate support for (e.g., whether the UE supports UL resource muting for) one or more of (1) a first maximum number of switches between different candidate UL resource muting time location configurations in the plurality of candidate UL resource muting time location configurations, (2) a second maximum number of switches between the different candidate UL resource muting time location configurations during a first duration, where the first duration is one of a first period associated with an SBFD configuration period (or a configured SBFD period), a second period associated with a TDD slot format pattern, a first number of slots, or a second number of milliseconds, or (3) a minimum time between switches between the different candidate UL resource muting time location configurations, where the minimum time is one of a third number slots or a fourth number of milliseconds.

The UE, in some aspects, may support multiple candidate UL resource muting time location configurations where the candidate UL resource muting time location configurations may be candidate SRS resource configurations (e.g., a SRS resource or SRS resource set may be used to identify the UL resource muting time location configurations and/or UL resources to be muted in association with the UL resource muting). In some aspects, each candidate SRS resource configuration in the set of candidate UL resource muting time location configurations may be associated with one of the first muted symbol, the second muted symbol, or a pattern associated with the first muted symbol and the second muted symbol for the UL resource muting. The indication 806, in some aspects, may indicate the support for the UL resource muting associated with the use of ZP SRS resources for the UL resource muting, and the indication may indicate support for (e.g., whether the UE supports UL resource muting for) one or more of: (1) a first maximum number of candidate SRS resource configurations associated with the first muted symbol (or the position and/or time location of the first muted symbol) for the UL resource muting and a second maximum number of candidate SRS resource configurations associated with the second muted symbol (or the position and/or time location of the second muted symbol) for the UL resource muting, (2) a third maximum number of candidate SRS resource configurations associated with a pattern associated with the first muted symbol and the second muted symbol (e.g., a pattern including the position and/or time location of the first muted symbol for the UL resource muting and/or the position and/or time location of the second muted symbol) for the UL resource muting, (3) a fourth maximum number of switches between different candidate SRS resource configurations, (4) a fifth maximum number of switches between the different candidate SRS resource configurations during a first duration, wherein the first duration is one of a first period associated with an SBFD configuration period (or a configured SBFD period), a second period associated with a TDD slot format pattern, a first number of slots, or a second number of milliseconds, or (5) a minimum time between switches between the different candidate SRS resource configurations, where the minimum time is one of a third number slots or a fourth number of milliseconds.

In some aspects, the indication of support may indicate the support for the UL resource muting associated with the one or more UL waveforms, and the indication of support may indicate support for (e.g., whether the UE supports UL resource muting for) one or more of: (1) the UL resource muting associated with a DFT-s-OFDM waveform for UL, (2) the UL resource muting associated with a CP-OFDM waveform for UL, (3) a same UL resource muting configuration for the DFT-s-OFDM waveform and the CP-OFDM waveform, or (4) different UL resource muting configurations for the DFT-s-OFDM waveform and the CP-OFDM waveform.

The indication of support, in some aspects, may indicate the support for the UL resource muting associated with the one or more transmission types, and wherein the indication indicates support for (e.g., whether the UE supports UL resource muting for) one or more of: (1) the UL resource muting for a CG PUSCH, (2) the UL resource muting for a dynamic grant PUSCH, (3) the UL resource muting for a TBoMS PUSCH, (4) the UL resource muting for a first PUSCH associated with one or more of a first type of repetition (e.g., a Type A repetition) or a second type of the repetition (e.g., a Type B repetition), (5) the UL resource muting for a second PUSCH with intra-slot frequency hopping, (6) the UL resource muting for a third PUSCH with inter-slot frequency hopping, or (7) the UL resource muting for a fourth PUSCH associated with one or more of a first type of resource mapping (e.g., a Type A resource mapping) or a second type of the resource mapping (e.g., a Type B resource mapping).

In some aspects, the indication of support may indicate the support for the UL resource muting associated with the maximum number of muted symbols in the time window, and the indication of support may indicate support for (e.g., whether the UE supports UL resource muting for) one or more of: (1) a first maximum number of muted symbols within the slot or (2) a second maximum number of muted symbols within a mini-slot.

The indication of support, in some aspects, may indicate the support for the UL resource muting associated with the slot type, and the indication of support may indicate support for (e.g., whether the UE supports UL resource muting for) one or more of: (1) the UL resource muting on SBFD symbols, (2) the UL resource muting on non-SBFD symbols, (3) a same UL resource muting configuration for the SBFD symbols and the non-SBFD symbols, or (4) different UL resource muting configurations for the SBFD symbols and the non-SBFD symbols.

In some aspects, the indication of support may indicate the support for the UL resource muting associated with the power boosting of the unmuted PUSCH resources, and the indication of support may indicate that (or whether) the UE supports the power boosting on the unmuted PUSCH resources transmitted in a first symbol during which the UL resource muting is applied (e.g., supports power boosting for unmuted REs used to transmit the PUSCH transmission in a muted symbol). Based on the power boosting of the unmuted PUSCH resources, in some aspects, the power may not change across the symbols of the PUSCH transmission (e.g., across unmuted symbols and muted symbols) such that a first transmitted power associated with the first symbol and a second transmitted power associated with a second symbol during which the UL resource muting is not applied are a same power (where a same power may refer to being within a power difference threshold that is less than 3 dB, less than 1 dB or some other threshold value configured for the power boosting).

The indication of support, in some aspects, may indicate the support for the UL resource muting associated with the minimum frequency domain allocation of the PUSCH to which the UL resource muting may be applied, and the indication may indicate a minimum number of frequency resources associated with (or allocated to or for) a PUSCH for which the UE supports the UL resource muting. In some aspects, the frequency resources may be one of resource blocks or sub-carriers. Accordingly, the UE may not support UL resource muting for an UL transmission allocated fewer than the minimum number of frequency resources (e.g., the UE may not be capable of applying UL resource muting to an UL transmission spanning a frequency range that is smaller than the minimum number of frequency resources).

In some aspects, the indication of support may indicate the support for the UL resource muting associated with the minimum time domain allocation of the PUSCH to which the UL resource muting may be applied, and the indication may indicate a minimum number of time-domain resources associated with (or allocated to or for) a PUSCH for which the UE supports the UL resource muting. The time-domain resources, in some aspects, may be one of slots, symbols, or milliseconds. Accordingly, the UE may not support UL resource muting for an UL transmission allocated fewer than the minimum number of time domain resources (e.g., the UE may not be capable of applying UL resource muting to an UL transmission spanning a time and/or duration that is smaller than the minimum number of time domain resources).

At 1004, the UE may, based on the indication, receive at least one UL resource muting configuration supported by the UE. For example, 1004 may be performed by application processor(s) 1306, cellular baseband processor(s) 1324, transceiver(s) 1322, antenna(s) 1380, and/or UL resource muting capability component 198 of FIG. 13. In some aspects, the at least one UL resource muting configuration may be, or include, a set of candidate UL resource muting time location configurations (e.g., UL resource muting time location configurations that may be activated and/or selected). The set of candidate UL resource muting time location configurations, in some aspects, may be associated with one or more of: (1) a first position within a slot of a first muted symbol for the UL resource muting, (2) a second position within the slot of the first muted symbol for the UL resource muting, (3) a third position within the slot of a second muted symbol for the UL resource muting, or (4) a fourth position within the slot of a second muted symbol for the UL resource muting. In some aspects, each candidate UL resource muting time location configuration in the set of candidate UL resource muting time location configurations may be associated with, indicate, or specify, one or more of: (1) a (first and/or corresponding) position within a slot of a first muted symbol for the UL resource muting or (2) a (second and/or corresponding) position within the slot of a second muted symbol for the UL resource muting. In some aspects, the set of candidate UL resource muting time location configurations may include, or be, candidate SRS resource configurations (e.g., SRS resources or SRS resource sets previously defined for SRS transmission that may be selected for ZP SRS and/or UL resource muting). The at least one UL resource muting configuration, in some aspects, may include and/or be associated with additional parameters for the UL resource muting based on the aspects of the UL resource muting indicated to be supported by the indication transmitted at 1002 (e.g., as a UE capability indication). For example, referring to FIG. 8, the base station 802 may transmit, and the UE 804 may receive, the at least one UL resource muting configuration(s) 808.

At 1006, the UE may transmit an UL transmission with the UL resource muting based on an UL resource muting configuration from the at least one UL resource muting configuration. For example, 1006 may be performed by application processor(s) 1306, cellular baseband processor(s) 1324, transceiver(s) 1322, antenna(s) 1380, and/or UL resource muting capability component 198 of FIG. 13. In some aspects, the UL resource muting configuration may include a UL resource muting time location configuration. For example, referring to FIG. 8, the UE 804 may, at 814, apply the UL resource muting to the UL transmission 816 and the UE 804 may transmit, and the base station 802 may receive, the UL transmission 816 to which the UL resource muting has been applied based on the at least one UL resource muting configuration(s) 808, the UL resource muting activation indication 810, and/or the UL resource muting configuration selection indication 812.

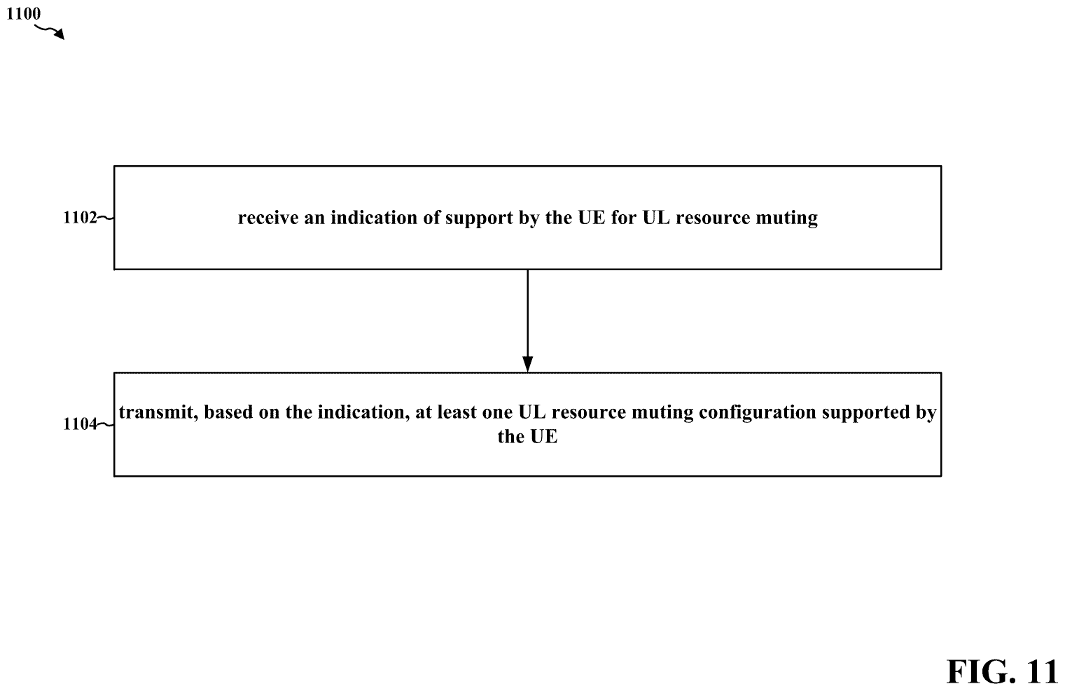

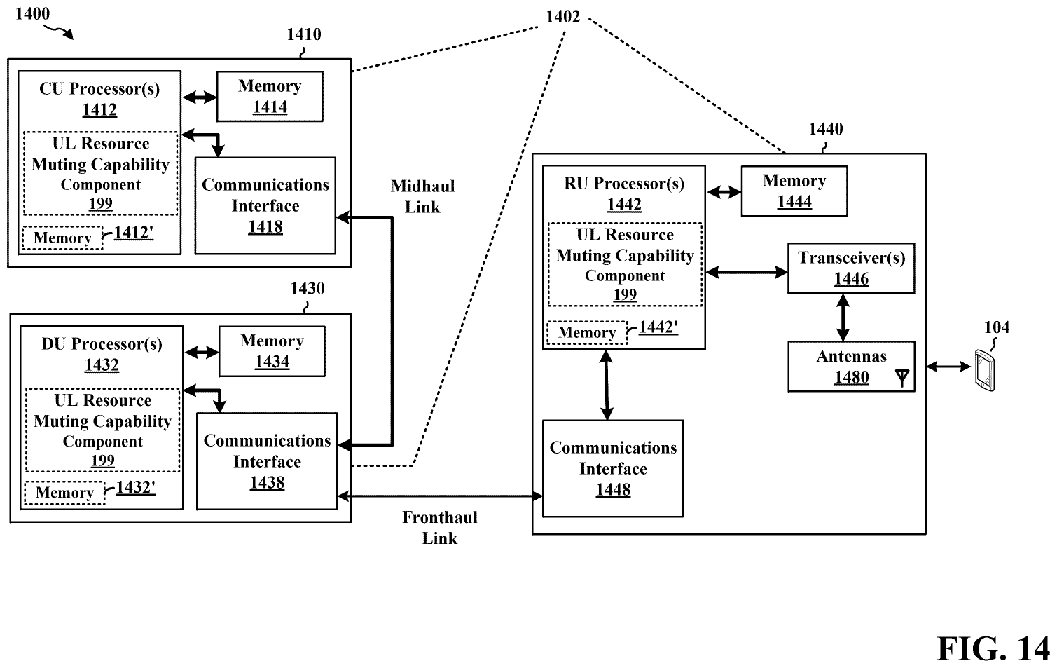

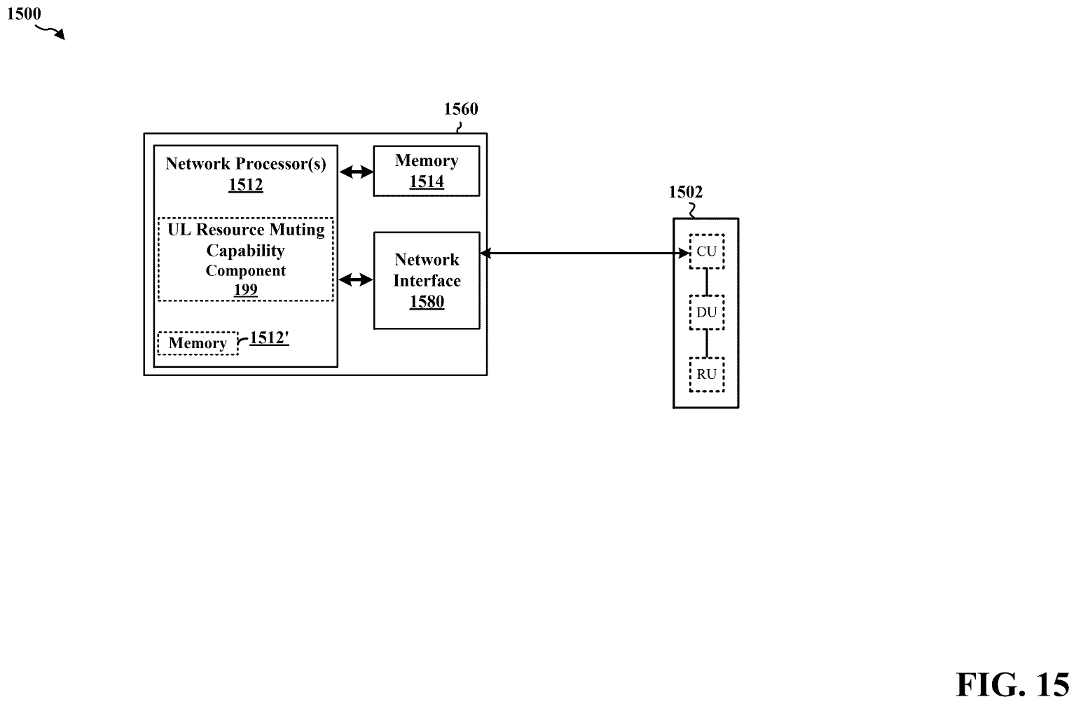

FIG. 11 is a flowchart 1100 of a method of wireless communication. The method may be performed by a network device such as a base station (e.g., the base station 102, 802; the network entity 1302, 1402, 1560). At 1102, the base station may receive an indication of support by a UE for UL resource muting. The indication of support, in some aspects, may be a UE capability indication. For example, 1102 may be performed by CU processor(s) 1412, DU processor(s) 1432, RU processor(s) 1442, transceiver(s) 1446, antenna(s) 1480, network processor 1512, network interface 1580, and/or UL resource muting capability component 199 of FIGS. 14 and 15. The indication of support by the UE for the UL resource muting may be associated with one or more of (1) UL resource muting activation, (2) a number of UL resource muting time location configurations supported by the UE, (3) UL resource muting time location configuration switching, (4) a use of ZP SRS resources (or ZP SRS resource sets) for the UL resource muting, (5) one or more UL waveforms (e.g., waveforms that may have UL resource muting applied), (6) one or more transmission types (e.g., transmission types that may have UL resource muting applied), (7) a maximum number of muted symbols in a time window, (8) a slot type (e.g., one or more slot types that may have UL resource muting applied), (9) power boosting of unmuted PUSCH resources (e.g., power boosting of unmuted REs in a muted symbol in association with the UL resource muting), (10) a minimum frequency domain allocation of, or for, a PUSCH to which the UL resource muting may be applied, or (11) a minimum time domain allocation of, or for, a PUSCH to which the UL resource muting may be applied. For example, referring to FIG. 8, the UE 804 may transmit, and the base station 802 may receive, the indication 806 (e.g., a UE capability indication) indicating support by the UE 804 for UL resource muting.

As will be explained in relation to the at least one UL resource muting configuration supported by the UE received at 904, the UE may receive at least one UL resource muting configuration that may include a set of candidate UL resource muting time location configurations (e.g., UL resource muting time location configurations that may be activated and/or selected). The set of candidate UL resource muting time location configurations, in some aspects, may be associated with one or more of: (1) a first position and/or time location within a slot of a first muted symbol for the UL resource muting, (2) a second position and/or time location within the slot of the first muted symbol for the UL resource muting, (3) a third position and/or time location within the slot of a second muted symbol for the UL resource muting, or (4) a fourth position and/or time location within the slot of a second muted symbol for the UL resource muting. In some aspects, each candidate UL resource muting time location configuration in the set of candidate UL resource muting time location configurations may be associated with, indicate, or specify, one or more of: (1) a (first and/or corresponding) position and/or time location within a slot of a first muted symbol for the UL resource muting or (2) a (second and/or corresponding) position and/or time location within the slot of a second muted symbol for the UL resource muting.

In some aspects, the indication of support may indicate the support for the UL resource muting associated with the UL resource muting activation, and the indication of support may indicate support for (e.g., whether the UE supports UL resource muting for) one or more of a dynamic activation and a dynamic deactivation of the UL resource muting. The indication of support, in some aspects, may indicate the support for the UL resource muting associated with the UL resource muting activation, and the indication of support may indicate support for one or more of a dynamic indication and/or activation of a candidate UL resource muting time location configuration.

The indication of support, in some aspects, may indicate the support for the UL resource muting associated with the number of UL resource muting time location configurations supported by the UE, each candidate UL resource muting time location configuration in the set of candidate UL resource muting time location configurations may be associated with one of the first muted symbol, the second muted symbol, or a pattern associated with the first muted symbol and the second muted symbol for the UL resource muting, and the indication 806 may indicate support for (e.g., whether the UE supports UL resource muting for) one or more of (1) a first maximum number of candidate UL resource muting time location configurations associated with the first muted symbol (or the position and/or time location of the first muted symbol) for the UL resource muting and a second maximum number of candidate UL resource muting time location configurations associated with the second muted symbol (or the position and/or time location of the second muted symbol) for the UL resource muting (where the first maximum number and the second maximum number may be the same or may be different), or (2) a third maximum number of candidate UL resource muting time location configurations associated with a pattern associated with the first muted symbol and the second muted symbol (e.g., a pattern including the position and/or time location of the first muted symbol for the UL resource muting and/or the position and/or time location of the second muted symbol) for the UL resource muting.

In some aspects, the UE may support multiple candidate UL resource muting time location configurations. The indication of support, in some aspects, may indicate the support for the UL resource muting associated with the UL resource muting time location configuration switching, and the indication of support may indicate support for (e.g., whether the UE supports UL resource muting for) one or more of (1) a first maximum number of switches between different candidate UL resource muting time location configurations in the plurality of candidate UL resource muting time location configurations, (2) a second maximum number of switches between the different candidate UL resource muting time location configurations during a first duration, where the first duration is one of a first period associated with an SBFD configuration period (or a configured SBFD period), a second period associated with a TDD slot format pattern, a first number of slots, or a second number of milliseconds, or (3) a minimum time between switches between the different candidate UL resource muting time location configurations, where the minimum time is one of a third number slots or a fourth number of milliseconds.

The UE, in some aspects, may support multiple candidate UL resource muting time location configurations where the candidate UL resource muting time location configurations may be candidate SRS resource configurations (e.g., a SRS resource or SRS resource set may be used to identify the UL resource muting time location configurations and/or UL resources to be muted in association with the UL resource muting). In some aspects, each candidate SRS resource configuration in the set of candidate UL resource muting time location configurations may be associated with one of the first muted symbol, the second muted symbol, or a pattern associated with the first muted symbol and the second muted symbol for the UL resource muting. The indication 806, in some aspects, may indicate the support for the UL resource muting associated with the use of ZP SRS resources for the UL resource muting, and the indication may indicate support for (e.g., whether the UE supports UL resource muting for) one or more of: (1) a first maximum number of candidate SRS resource configurations associated with the first muted symbol (or the position and/or time location of the first muted symbol) for the UL resource muting and a second maximum number of candidate SRS resource configurations associated with the second muted symbol (or the position and/or time location of the second muted symbol) for the UL resource muting, (2) a third maximum number of candidate SRS resource configurations associated with a pattern associated with the first muted symbol and the second muted symbol (e.g., a pattern including the position and/or time location of the first muted symbol for the UL resource muting and/or the position and/or time location of the second muted symbol) for the UL resource muting, (3) a fourth maximum number of switches between different candidate SRS resource configurations, (4) a fifth maximum number of switches between the different candidate SRS resource configurations during a first duration, wherein the first duration is one of a first period associated with an SBFD configuration period (or a configured SBFD period), a second period associated with a TDD slot format pattern, a first number of slots, or a second number of milliseconds, or (5) a minimum time between switches between the different candidate SRS resource configurations, where the minimum time is one of a third number slots or a fourth number of milliseconds.

In some aspects, the indication of support may indicate the support for the UL resource muting associated with the one or more UL waveforms, and the indication of support may indicate support for (e.g., whether the UE supports UL resource muting for) one or more of: (1) the UL resource muting associated with a DFT-s-OFDM waveform for UL, (2) the UL resource muting associated with a CP-OFDM waveform for UL, (3) a same UL resource muting configuration for the DFT-s-OFDM waveform and the CP-OFDM waveform, or (4) different UL resource muting configurations for the DFT-s-OFDM waveform and the CP-OFDM waveform.

The indication of support, in some aspects, may indicate the support for the UL resource muting associated with the one or more transmission types, and wherein the indication indicates support for (e.g., whether the UE supports UL resource muting for) one or more of: (1) the UL resource muting for a CG PUSCH, (2) the UL resource muting for a dynamic grant PUSCH, (3) the UL resource muting for a TBoMS PUSCH, (4) the UL resource muting for a first PUSCH associated with one or more of a first type of repetition (e.g., a Type A repetition) or a second type of the repetition (e.g., a Type B repetition), (5) the UL resource muting for a second PUSCH with intra-slot frequency hopping, (6) the UL resource muting for a third PUSCH with inter-slot frequency hopping, or (7) the UL resource muting for a fourth PUSCH associated with one or more of a first type of resource mapping (e.g., a Type A resource mapping) or a second type of the resource mapping (e.g., a Type B resource mapping).

In some aspects, the indication of support may indicate the support for the UL resource muting associated with the maximum number of muted symbols in the time window, and the indication of support may indicate support for (e.g., whether the UE supports UL resource muting for) one or more of: (1) a first maximum number of muted symbols within the slot or (2) a second maximum number of muted symbols within a mini-slot.

The indication of support, in some aspects, may indicate the support for the UL resource muting associated with the slot type, and the indication of support may indicate support for (e.g., whether the UE supports UL resource muting for) one or more of: (1) the UL resource muting on SBFD symbols, (2) the UL resource muting on non-SBFD symbols, (3) a same UL resource muting configuration for the SBFD symbols and the non-SBFD symbols, or (4) different UL resource muting configurations for the SBFD symbols and the non-SBFD symbols.

In some aspects, the indication of support may indicate the support for the UL resource muting associated with the power boosting of the unmuted PUSCH resources, and the indication of support may indicate that (or whether) the UE supports the power boosting on the unmuted PUSCH resources transmitted in a first symbol during which the UL resource muting is applied (e.g., supports power boosting for unmuted REs used to transmit the PUSCH transmission in a muted symbol). Based on the power boosting of the unmuted PUSCH resources, in some aspects, the power may not change across the symbols of the PUSCH transmission (e.g., across unmuted symbols and muted symbols) such that a first transmitted power associated with the first symbol and a second transmitted power associated with a second symbol during which the UL resource muting is not applied are a same power (where a same power may refer to being within a power difference threshold that is less than 3 dB, less than 1 dB or some other threshold value configured for the power boosting).

The indication of support, in some aspects, may indicate the support for the UL resource muting associated with the minimum frequency domain allocation of the PUSCH to which the UL resource muting may be applied, and the indication may indicate a minimum number of frequency resources associated with (or allocated to or for) a PUSCH for which the UE supports the UL resource muting. In some aspects, the frequency resources may be one of resource blocks or sub-carriers. Accordingly, the UE may not support UL resource muting for an UL transmission allocated fewer than the minimum number of frequency resources (e.g., the UE may not be capable of applying UL resource muting to an UL transmission spanning a frequency range that is smaller than the minimum number of frequency resources).

In some aspects, the indication of support may indicate the support for the UL resource muting associated with the minimum time domain allocation of the PUSCH to which the UL resource muting may be applied, and the indication may indicate a minimum number of time-domain resources associated with (or allocated to or for) a PUSCH for which the UE supports the UL resource muting. The time-domain resources, in some aspects, may be one of slots, symbols, or milliseconds. Accordingly, the UE may not support UL resource muting for an UL transmission allocated fewer than the minimum number of time domain resources (e.g., the UE may not be capable of applying UL resource muting to an UL transmission spanning a time and/or duration that is smaller than the minimum number of time domain resources).

At 1104, the base station may, based on the indication, transmit at least one UL resource muting configuration supported by the UE. For example, 1104 may be performed by CU processor(s) 1412, DU processor(s) 1432, RU processor(s) 1442, transceiver(s) 1446, antenna(s) 1480, network processor 1512, network interface 1580, and/or UL resource muting capability component 199 of FIGS. 14 and 15. In some aspects, the at least one UL resource muting configuration may be, or include, a set of candidate UL resource muting time location configurations (e.g., UL resource muting time location configurations that may be activated and/or selected). The set of candidate UL resource muting time location configurations, in some aspects, may be associated with one or more of: (1) a first position within a slot of a first muted symbol for the UL resource muting, (2) a second position within the slot of the first muted symbol for the UL resource muting, (3) a third position within the slot of a second muted symbol for the UL resource muting, or (4) a fourth position within the slot of a second muted symbol for the UL resource muting. In some aspects, each candidate UL resource muting time location configuration in the set of candidate UL resource muting time location configurations may be associated with, indicate, or specify, one or more of: (1) a (first and/or corresponding) position within a slot of a first muted symbol for the UL resource muting or (2) a (second and/or corresponding) position within the slot of a second muted symbol for the UL resource muting. In some aspects, the set of candidate UL resource muting time location configurations may include, or be, candidate SRS resource configurations (e.g., SRS resources or SRS resource sets previously defined for SRS transmission that may be selected for ZP SRS and/or UL resource muting). The at least one UL resource muting configuration, in some aspects, may include and/or be associated with additional parameters for the UL resource muting based on the aspects of the UL resource muting indicated to be supported by the indication received at 1102 (e.g., as a UE capability indication). For example, referring to FIG. 8, the base station 802 may transmit, and the UE 804 may receive, the at least one UL resource muting configuration(s) 808.

In some aspects, the base station may receive an UL transmission with the UL resource muting based on an UL resource muting configuration from the at least one UL resource muting configuration. In some aspects, the UL resource muting configuration may include a UL resource muting time location configuration. For example, referring to FIG. 8, the UE 804 may, at 814, apply the UL resource muting to the UL transmission 816 and the UE 804 may transmit, and the base station 802 may receive, the UL transmission 816 to which the UL resource muting has been applied based on the at least one UL resource muting configuration(s) 808, the UL resource muting activation indication 810, and/or the UL resource muting configuration selection indication 812.

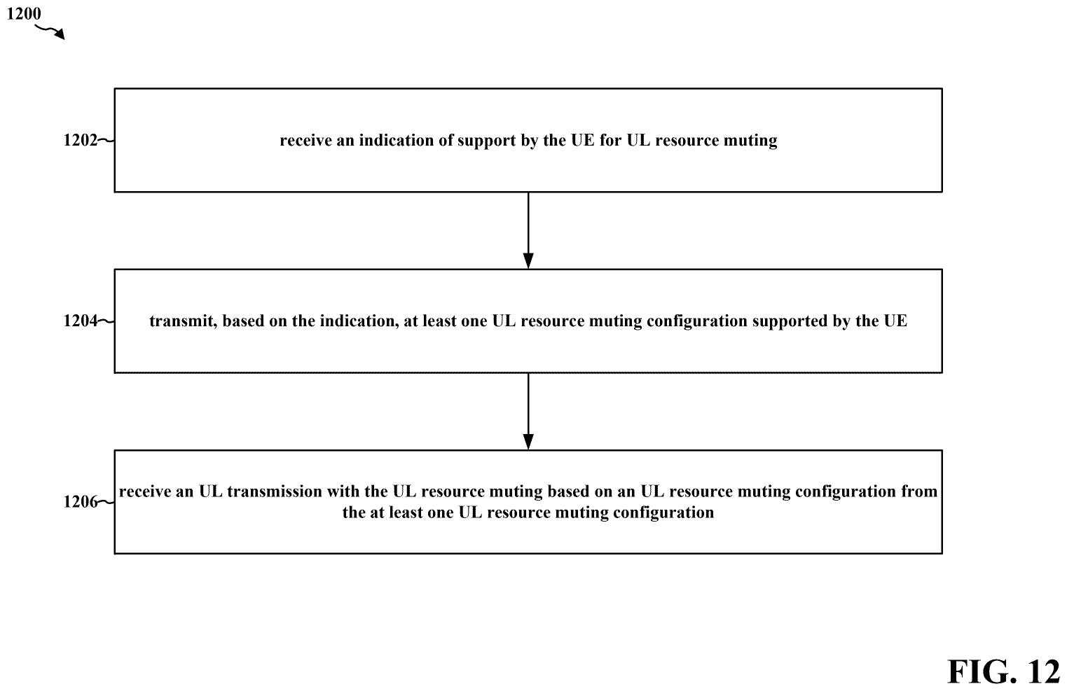

FIG. 12 is a flowchart 1200 of a method of wireless communication. The method may be performed by a network device such as a base station (e.g., the base station 102, 802; the network entity 1302, 1402, 1560). At 1202, the base station may receive an indication of support by a UE for UL resource muting. The indication of support, in some aspects, may be a UE capability indication. For example, 1202 may be performed by CU processor(s) 1412, DU processor(s) 1432, RU processor(s) 1442, transceiver(s) 1446, antenna(s) 1480, network processor 1512, network interface 1580, and/or UL resource muting capability component 199 of FIGS. 14 and 15. The indication of support by the UE for the UL resource muting may be associated with one or more of (1) UL resource muting activation, (2) a number of UL resource muting time location configurations supported by the UE, (3) UL resource muting time location configuration switching, (4) a use of ZP SRS resources (or ZP SRS resource sets) for the UL resource muting, (5) one or more UL waveforms (e.g., waveforms that may have UL resource muting applied), (6) one or more transmission types (e.g., transmission types that may have UL resource muting applied), (7) a maximum number of muted symbols in a time window, (8) a slot type (e.g., one or more slot types that may have UL resource muting applied), (9) power boosting of unmuted PUSCH resources (e.g., power boosting of unmuted REs in a muted symbol in association with the UL resource muting), (10) a minimum frequency domain allocation of, or for, a PUSCH to which the UL resource muting may be applied, or (11) a minimum time domain allocation of, or for, a PUSCH to which the UL resource muting may be applied. For example, referring to FIG. 8, the UE 804 may transmit, and the base station 802 may receive, the indication 806 (e.g., a UE capability indication) indicating support by the UE 804 for UL resource muting.

As will be explained in relation to the at least one UL resource muting configuration supported by the UE received at 904, the UE may receive at least one UL resource muting configuration that may include a set of candidate UL resource muting time location configurations (e.g., UL resource muting time location configurations that may be activated and/or selected). The set of candidate UL resource muting time location configurations, in some aspects, may be associated with one or more of: (1) a first position and/or time location within a slot of a first muted symbol for the UL resource muting, (2) a second position and/or time location within the slot of the first muted symbol for the UL resource muting, (3) a third position and/or time location within the slot of a second muted symbol for the UL resource muting, or (4) a fourth position and/or time location within the slot of a second muted symbol for the UL resource muting. In some aspects, each candidate UL resource muting time location configuration in the set of candidate UL resource muting time location configurations may be associated with, indicate, or specify, one or more of: (1) a (first and/or corresponding) position and/or time location within a slot of a first muted symbol for the UL resource muting or (2) a (second and/or corresponding) position and/or time location within the slot of a second muted symbol for the UL resource muting.

In some aspects, the indication of support may indicate the support for the UL resource muting associated with the UL resource muting activation, and the indication of support may indicate support for (e.g., whether the UE supports UL resource muting for) one or more of a dynamic activation and a dynamic deactivation of the UL resource muting. The indication of support, in some aspects, may indicate the support for the UL resource muting associated with the UL resource muting activation, and the indication of support may indicate support for one or more of a dynamic indication and/or activation of a candidate UL resource muting time location configuration.

The indication of support, in some aspects, may indicate the support for the UL resource muting associated with the number of UL resource muting time location configurations supported by the UE, each candidate UL resource muting time location configuration in the set of candidate UL resource muting time location configurations may be associated with one of the first muted symbol, the second muted symbol, or a pattern associated with the first muted symbol and the second muted symbol for the UL resource muting, and the indication 806 may indicate support for (e.g., whether the UE supports UL resource muting for) one or more of (1) a first maximum number of candidate UL resource muting time location configurations associated with the first muted symbol (or the position and/or time location of the first muted symbol) for the UL resource muting and a second maximum number of candidate UL resource muting time location configurations associated with the second muted symbol (or the position and/or time location of the second muted symbol) for the UL resource muting (where the first maximum number and the second maximum number may be the same or may be different), or (2) a third maximum number of candidate UL resource muting time location configurations associated with a pattern associated with the first muted symbol and the second muted symbol (e.g., a pattern including the position and/or time location of the first muted symbol for the UL resource muting and/or the position and/or time location of the second muted symbol) for the UL resource muting.

In some aspects, the UE may support multiple candidate UL resource muting time location configurations. The indication of support, in some aspects, may indicate the support for the UL resource muting associated with the UL resource muting time location configuration switching, and the indication of support may indicate support for (e.g., whether the UE supports UL resource muting for) one or more of (1) a first maximum number of switches between different candidate UL resource muting time location configurations in the plurality of candidate UL resource muting time location configurations, (2) a second maximum number of switches between the different candidate UL resource muting time location configurations during a first duration, where the first duration is one of a first period associated with an SBFD configuration period (or a configured SBFD period), a second period associated with a TDD slot format pattern, a first number of slots, or a second number of milliseconds, or (3) a minimum time between switches between the different candidate UL resource muting time location configurations, where the minimum time is one of a third number slots or a fourth number of milliseconds.

The UE, in some aspects, may support multiple candidate UL resource muting time location configurations where the candidate UL resource muting time location configurations may be candidate SRS resource configurations (e.g., a SRS resource or SRS resource set may be used to identify the UL resource muting time location configurations and/or UL resources to be muted in association with the UL resource muting). In some aspects, each candidate SRS resource configuration in the set of candidate UL resource muting time location configurations may be associated with one of the first muted symbol, the second muted symbol, or a pattern associated with the first muted symbol and the second muted symbol for the UL resource muting. The indication 806, in some aspects, may indicate the support for the UL resource muting associated with the use of ZP SRS resources for the UL resource muting, and the indication may indicate support for (e.g., whether the UE supports UL resource muting for) one or more of: (1) a first maximum number of candidate SRS resource configurations associated with the first muted symbol (or the position and/or time location of the first muted symbol) for the UL resource muting and a second maximum number of candidate SRS resource configurations associated with the second muted symbol (or the position and/or time location of the second muted symbol) for the UL resource muting, (2) a third maximum number of candidate SRS resource configurations associated with a pattern associated with the first muted symbol and the second muted symbol (e.g., a pattern including the position and/or time location of the first muted symbol for the UL resource muting and/or the position and/or time location of the second muted symbol) for the UL resource muting, (3) a fourth maximum number of switches between different candidate SRS resource configurations, (4) a fifth maximum number of switches between the different candidate SRS resource configurations during a first duration, wherein the first duration is one of a first period associated with an SBFD configuration period (or a configured SBFD period), a second period associated with a TDD slot format pattern, a first number of slots, or a second number of milliseconds, or (5) a minimum time between switches between the different candidate SRS resource configurations, where the minimum time is one of a third number slots or a fourth number of milliseconds.

In some aspects, the indication of support may indicate the support for the UL resource muting associated with the one or more UL waveforms, and the indication of support may indicate support for (e.g., whether the UE supports UL resource muting for) one or more of: (1) the UL resource muting associated with a DFT-s-OFDM waveform for UL, (2) the UL resource muting associated with a CP-OFDM waveform for UL, (3) a same UL resource muting configuration for the DFT-s-OFDM waveform and the CP-OFDM waveform, or (4) different UL resource muting configurations for the DFT-s-OFDM waveform and the CP-OFDM waveform.

The indication of support, in some aspects, may indicate the support for the UL resource muting associated with the one or more transmission types, and wherein the indication indicates support for (e.g., whether the UE supports UL resource muting for) one or more of: (1) the UL resource muting for a CG PUSCH, (2) the UL resource muting for a dynamic grant PUSCH, (3) the UL resource muting for a TBoMS PUSCH, (4) the UL resource muting for a first PUSCH associated with one or more of a first type of repetition (e.g., a Type A repetition) or a second type of the repetition (e.g., a Type B repetition), (5) the UL resource muting for a second PUSCH with intra-slot frequency hopping, (6) the UL resource muting for a third PUSCH with inter-slot frequency hopping, or (7) the UL resource muting for a fourth PUSCH associated with one or more of a first type of resource mapping (e.g., a Type A resource mapping) or a second type of the resource mapping (e.g., a Type B resource mapping).

In some aspects, the indication of support may indicate the support for the UL resource muting associated with the maximum number of muted symbols in the time window, and the indication of support may indicate support for (e.g., whether the UE supports UL resource muting for) one or more of: (1) a first maximum number of muted symbols within the slot or (2) a second maximum number of muted symbols within a mini-slot.

The indication of support, in some aspects, may indicate the support for the UL resource muting associated with the slot type, and the indication of support may indicate support for (e.g., whether the UE supports UL resource muting for) one or more of: (1) the UL resource muting on SBFD symbols, (2) the UL resource muting on non-SBFD symbols, (3) a same UL resource muting configuration for the SBFD symbols and the non-SBFD symbols, or (4) different UL resource muting configurations for the SBFD symbols and the non-SBFD symbols.

In some aspects, the indication of support may indicate the support for the UL resource muting associated with the power boosting of the unmuted PUSCH resources, and the indication of support may indicate that (or whether) the UE supports the power boosting on the unmuted PUSCH resources transmitted in a first symbol during which the UL resource muting is applied (e.g., supports power boosting for unmuted REs used to transmit the PUSCH transmission in a muted symbol). Based on the power boosting of the unmuted PUSCH resources, in some aspects, the power may not change across the symbols of the PUSCH transmission (e.g., across unmuted symbols and muted symbols) such that a first transmitted power associated with the first symbol and a second transmitted power associated with a second symbol during which the UL resource muting is not applied are a same power (where a same power may refer to being within a power difference threshold that is less than 3 dB, less than 1 dB or some other threshold value configured for the power boosting).

The indication of support, in some aspects, may indicate the support for the UL resource muting associated with the minimum frequency domain allocation of the PUSCH to which the UL resource muting may be applied, and the indication may indicate a minimum number of frequency resources associated with (or allocated to or for) a PUSCH for which the UE supports the UL resource muting. In some aspects, the frequency resources may be one of resource blocks or sub-carriers. Accordingly, the UE may not support UL resource muting for an UL transmission allocated fewer than the minimum number of frequency resources (e.g., the UE may not be capable of applying UL resource muting to an UL transmission spanning a frequency range that is smaller than the minimum number of frequency resources).

In some aspects, the indication of support may indicate the support for the UL resource muting associated with the minimum time domain allocation of the PUSCH to which the UL resource muting may be applied, and the indication may indicate a minimum number of time-domain resources associated with (or allocated to or for) a PUSCH for which the UE supports the UL resource muting. The time-domain resources, in some aspects, may be one of slots, symbols, or milliseconds. Accordingly, the UE may not support UL resource muting for an UL transmission allocated fewer than the minimum number of time domain resources (e.g., the UE may not be capable of applying UL resource muting to an UL transmission spanning a time and/or duration that is smaller than the minimum number of time domain resources).

At 1204, the base station may, based on the indication, transmit at least one UL resource muting configuration supported by the UE. For example, 1204 may be performed by CU processor(s) 1412, DU processor(s) 1432, RU processor(s) 1442, transceiver(s) 1446, antenna(s) 1480, network processor 1512, network interface 1580, and/or UL resource muting capability component 199 of FIGS. 14 and 15. In some aspects, the at least one UL resource muting configuration may be, or include, a set of candidate UL resource muting time location configurations (e.g., UL resource muting time location configurations that may be activated and/or selected). The set of candidate UL resource muting time location configurations, in some aspects, may be associated with one or more of: (1) a first position within a slot of a first muted symbol for the UL resource muting, (2) a second position within the slot of the first muted symbol for the UL resource muting, (3) a third position within the slot of a second muted symbol for the UL resource muting, or (4) a fourth position within the slot of a second muted symbol for the UL resource muting. In some aspects, each candidate UL resource muting time location configuration in the set of candidate UL resource muting time location configurations may be associated with, indicate, or specify, one or more of: (1) a (first and/or corresponding) position within a slot of a first muted symbol for the UL resource muting or (2) a (second and/or corresponding) position within the slot of a second muted symbol for the UL resource muting. In some aspects, the set of candidate UL resource muting time location configurations may include, or be, candidate SRS resource configurations (e.g., SRS resources or SRS resource sets previously defined for SRS transmission that may be selected for ZP SRS and/or UL resource muting). The at least one UL resource muting configuration, in some aspects, may include and/or be associated with additional parameters for the UL resource muting based on the aspects of the UL resource muting indicated to be supported by the indication received at 1202 (e.g., as a UE capability indication). For example, referring to FIG. 8, the base station 802 may transmit, and the UE 804 may receive, the at least one UL resource muting configuration(s) 808.

At 1206, the base station may receive an UL transmission with the UL resource muting based on an UL resource muting configuration from the at least one UL resource muting configuration. For example, 1206 may be performed by CU processor(s) 1412, DU processor(s) 1432, RU processor(s) 1442, transceiver(s) 1446, antenna(s) 1480, network processor 1512, network interface 1580, and/or UL resource muting capability component 199 of FIGS. 14 and 15. In some aspects, the UL resource muting configuration may include a UL resource muting time location configuration. For example, referring to FIG. 8, the UE 804 may, at 814, apply the UL resource muting to the UL transmission 816 and the UE 804 may transmit, and the base station 802 may receive, the UL transmission 816 to which the UL resource muting has been applied based on the at least one UL resource muting configuration(s) 808, the UL resource muting activation indication 810, and/or the UL resource muting configuration selection indication 812.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize one or more antennas 1380 for communication. The cellular baseband processor(s) 1324 communicates through the transceiver(s) 1322 via the one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the UL resource muting capability component 198 may be configured to transmit an indication of support by a UE for UL resource muting associated with one or more of: UL resource muting activation, a number of UL resource muting time location configurations supported by the UE, UL resource muting time location configuration switching, a use of ZP SRS resources for the UL resource muting, one or more UL waveforms, one or more transmission types, a maximum number of muted symbols in a time window, a slot type, power boosting of unmuted PUSCH resources, a minimum frequency domain allocation of a PUSCH to which the UL resource muting may be applied, or a minimum time domain allocation of the PUSCH to which the UL resource muting may be applied, and receive, based on the indication, at least one UL resource muting configuration supported by the UE. The UL resource muting capability component 198 may be within the cellular baseband processor(s) 1324, the application processor(s) 1306, or both the cellular baseband processor(s) 1324 and the application processor(s) 1306. The UL resource muting capability component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for transmitting an indication of support by the UE for UL resource muting associated with one or more of: UL resource muting activation, a number of UL resource muting time location configurations supported by the UE, UL resource muting time location configuration switching, a use of ZP SRS resources for the UL resource muting, one or more UL waveforms, one or more transmission types, a maximum number of muted symbols in a time window, a slot type, power boosting of unmuted PUSCH resources, a minimum frequency domain allocation of a PUSCH to which the UL resource muting may be applied, or a minimum time domain allocation of the PUSCH to which the UL resource muting may be applied. The apparatus 1304, and in particular the cellular baseband processor(s) 1324 and/or the application processor(s) 1306, may include means for receiving, based on the indication, at least one UL resource muting configuration supported by the UE. The apparatus 1304, and in particular the cellular baseband processor(s) 1324 and/or the application processor(s) 1306, may include means for transmitting an UL transmission with the UL resource muting based on an UL resource muting configuration from the at least one UL resource muting configuration. The apparatus 1304 may further include means for performing any of the aspects described in connection with the flowcharts in FIG. 9 or 10, and/or performed by the UE in the communication flow of FIG. 8. The means may be the UL resource muting capability component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the UL resource muting capability component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor 1412. The CU processor(s) 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor 1432. The DU processor(s) 1432 may include on-chip memory 1432′. In some aspects, the DU 1430 may further include additional memory modules 1434 and a communications interface 1438. The DU 1430 communicates with the RU 1440 through a fronthaul link. The RU 1440 may include at least one RU processor 1442. The RU processor(s) 1442 may include on-chip memory 1442′. In some aspects, the RU 1440 may further include additional memory modules 1444, one or more transceivers 1446, one or more antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the UL resource muting capability component 199 may be configured to receive an indication of support by a UE for UL resource muting associated with one or more of: UL resource muting activation, a number of UL resource muting time location configurations supported by the UE, UL resource muting time location configuration switching, a use of ZP SRS resources for the UL resource muting, one or more UL waveforms, one or more transmission types, a maximum number of muted symbols in a time window, a slot type, power boosting of unmuted PUSCH resources, a minimum frequency domain allocation of a PUSCH to which the UL resource muting may be applied, or a minimum time domain allocation of the PUSCH to which the UL resource muting may be applied, and transmit, based on the indication, at least one UL resource muting configuration supported by the UE. The UL resource muting capability component 199 may be within one or more processors of one or more of the CU 1410, DU 1430, and the RU 1440. The UL resource muting capability component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 may include means for receiving an indication of support by the UE for UL resource muting associated with one or more of: UL resource muting activation, a number of UL resource muting time location configurations supported by the UE, UL resource muting time location configuration switching, a use of ZP SRS resources for the UL resource muting, one or more UL waveforms, one or more transmission types, a maximum number of muted symbols in a time window, a slot type, power boosting of unmuted PUSCH resources, a minimum frequency domain allocation of a PUSCH to which the UL resource muting may be applied, or a minimum time domain allocation of the PUSCH to which the UL resource muting may be applied. The network entity 1402 may include means for transmitting, based on the indication, at least one UL resource muting configuration supported by the UE. The network entity 1402 may include means for receiving an UL transmission with UL resource muting based on an UL resource muting configuration from the at least one UL resource muting configuration. The network entity 1402 may further include means for performing any of the aspects described in connection with the flowchart in FIGS. 11 and 12, and/or performed by the base station in the communication flow of FIG. 8. The means may be the UL resource muting capability component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 15 is a diagram 1500 illustrating an example of a hardware implementation for a network entity 1560. In one example, the network entity 1560 may be within the core network 120. The network entity 1560 may include at least one network processor 1512. The network processor(s) 1512 may include on-chip memory 1512′. In some aspects, the network entity 1560 may further include additional memory modules 1514. The network entity 1560 communicates via the network interface 1580 directly (e.g., backhaul link) or indirectly (e.g., through a RIC) with the CU 1502. The on-chip memory 1512′ and the additional memory modules 1514 may each be considered a computer-readable medium/memory. Each computer-readable medium/memory may be non-transitory. The network processor(s) 1512 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the UL resource muting capability component 199 may be configured to receive an indication of support by a UE for UL resource muting associated with one or more of: UL resource muting activation, a number of UL resource muting time location configurations supported by the UE, UL resource muting time location configuration switching, a use of ZP SRS resources for the UL resource muting, one or more UL waveforms, one or more transmission types, a maximum number of muted symbols in a time window, a slot type, power boosting of unmuted PUSCH resources, a minimum frequency domain allocation of a PUSCH to which the UL resource muting may be applied, or a minimum time domain allocation of the PUSCH to which the UL resource muting may be applied, and transmit, based on the indication, at least one UL resource muting configuration supported by the UE. The UL resource muting capability component 199 may be within the network processor(s) 1512. The UL resource muting capability component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1560 may include a variety of components configured for various functions. In one configuration, the network entity 1560 may include means for receiving an indication of support by the UE for UL resource muting associated with one or more of: UL resource muting activation, a number of UL resource muting time location configurations supported by the UE, UL resource muting time location configuration switching, a use of ZP SRS resources for the UL resource muting, one or more UL waveforms, one or more transmission types, a maximum number of muted symbols in a time window, a slot type, power boosting of unmuted PUSCH resources, a minimum frequency domain allocation of a PUSCH to which the UL resource muting may be applied, or a minimum time domain allocation of the PUSCH to which the UL resource muting may be applied. The network entity 1560 may include means for transmitting, based on the indication, at least one UL resource muting configuration supported by the UE. The network entity 1560 may include means for receiving an UL transmission with UL resource muting based on an UL resource muting configuration from the at least one UL resource muting configuration. The network entity 1560 may further include means for performing any of the aspects described in connection with the flowchart in FIGS. 11 and 12, and/or performed by the base station in the communication flow of FIG. 8. The means may be the UL resource muting capability component 199 of the network entity 1560 configured to perform the functions recited by the means.

Various aspects relate generally to defining a feature list for UL resource muting for inter-base station/gNB CLI handling, e.g., capabilities related to UL resource muting including support for various configurations, patterns, waveforms, switching, and/or UL channel types. Some aspects more specifically relate to a UE capability indication (or a set of indications) to indicate support for different features of UL resource muting. In some examples, a wireless device may be configured to transmit an indication of support by the UE for UL resource muting associated with one or more of: UL resource muting activation, a number of UL resource muting time location configurations supported by the UE, UL resource muting time location configuration switching, a use of ZP SRS resources for the UL resource muting, one or more UL waveforms, one or more transmission types, a maximum number of muted symbols in a time window, a slot type, power boosting of unmuted PUSCH resources, a minimum frequency domain allocation of a PUSCH to which the UL resource muting may be applied, or a minimum time domain allocation of the PUSCH to which the UL resource muting may be applied, and receive, based on the indication, at least one UL resource muting configuration supported by the UE. A network device such as a base station, in some aspects, may be configured to receive an indication of support by a UE for UL resource muting associated with one or more of: UL resource muting activation, a number of UL resource muting time location configurations supported by the UE, UL resource muting time location configuration switching, a use of ZP SRS resources for the UL resource muting, one or more UL waveforms, one or more transmission types, a maximum number of muted symbols in a time window, a slot type, power boosting of unmuted PUSCH resources, a minimum frequency domain allocation of a PUSCH to which the UL resource muting may be applied, or a minimum time domain allocation of the PUSCH to which the UL resource muting may be applied, and transmit, based on the indication, at least one UL resource muting configuration supported by the UE.

Particular aspects of the subject matter described in this disclosure can be implemented to realize one or more of the following potential advantages. In some examples, by transmitting a UE capability indication (or a set of indications), the described techniques can be used to optimize UL resource muting for CLI measurement.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: transmitting an indication of support by the UE for uplink (UL) resource muting associated with one or more of: UL resource muting activation, a number of UL resource muting time location configurations supported by the UE, UL resource muting time location configuration switching, a use of zero power (ZP) sounding reference signals (SRS) resources for the UL resource muting, one or more UL waveforms, one or more transmission types, a maximum number of muted symbols in a time window, a slot type, power boosting of unmuted physical UL shared channel (PUSCH) resources, a minimum frequency domain allocation of a PUSCH to which the UL resource muting may be applied, or a minimum time domain allocation of the PUSCH to which the UL resource muting may be applied; and receiving, based on the indication, at least one UL resource muting configuration supported by the UE.

Aspect 2 is the method of aspect 1, wherein the at least one UL resource muting configuration comprises a set of candidate UL resource muting time location configurations configured for the UL resource muting, and wherein the set of candidate UL resource muting time location configurations is associated with one or more of: a first position within a slot of a first muted symbol for the UL resource muting; a second position within the slot of the first muted symbol for the UL resource muting; a third position within the slot of a second muted symbol for the UL resource muting; or a fourth position within the slot of the second muted symbol for the UL resource muting.

Aspect 3 is the method of aspect 2, wherein the indication indicates the support for the UL resource muting associated with the UL resource muting activation, wherein the indication indicates support for one or more of a dynamic activation and a dynamic deactivation of the UL resource muting.

Aspect 4 is the method of any of aspects 2 and 3, wherein the indication indicates the support for the UL resource muting associated with the number of UL resource muting time location configurations supported by the UE, wherein each candidate UL resource muting time location configuration in the set of candidate UL resource muting time location configurations is associated with one of the first muted symbol, the second muted symbol, or a pattern associated with the first muted symbol and the second muted symbol for the UL resource muting, and wherein the indication indicates support for one or more of: a first maximum number of candidate UL resource muting time location configurations associated with the first position of the first muted symbol for the UL resource muting and a second maximum number of candidate UL resource muting time location configurations associated with the second position of the second muted symbol for the UL resource muting; or a third maximum number of candidate UL resource muting time location configurations associated with a pattern comprising the first position of the first muted symbol for the UL resource muting and the second position of the second muted symbol for the UL resource muting.

Aspect 5 is the method of any of aspects 2 to 4, wherein the set of candidate UL resource muting time location configurations comprises a plurality of candidate UL resource muting time location configurations, wherein the indication indicates the support for the UL resource muting associated with the UL resource muting time location configuration switching, and wherein the indication indicates support for one or more of: a first maximum number of switches between different candidate UL resource muting time location configurations in the plurality of candidate UL resource muting time location configurations; a second maximum number of switches between the different candidate UL resource muting time location configurations during a first duration, wherein the first duration is one of a first period associated with a sub-band full duplex (SBFD) configuration period, a second period associated with a time division duplexing (TDD) slot format pattern, a first number of slots, or a second number of milliseconds; or a minimum time between switches between the different candidate UL resource muting time location configurations, wherein the minimum time is one of a third number slots or a fourth number of milliseconds.

Aspect 6 is the method of any of aspects 2 to 5, wherein the indication indicates the support for the UL resource muting associated with the use of ZP SRS resources for the UL resource muting, wherein the set of candidate UL resource muting time location configurations comprises candidate SRS resource configurations, wherein each candidate SRS resource configuration in the set of candidate UL resource muting time location configurations is associated with one of the first muted symbol, the second muted symbol, or a pattern associated with the first muted symbol and the second muted symbol for the UL resource muting, and wherein the indication indicates support for one or more of: a first maximum number of candidate SRS resource configurations associated with the first position of the first muted symbol for the UL resource muting and a second maximum number of candidate SRS resource configurations associated with the second position of the second muted symbol for the UL resource muting; a third maximum number of candidate SRS resource configurations associated with a pattern comprising the first position of the first muted symbol for the UL resource muting and the second position of the second muted symbol for the UL resource muting; a fourth maximum number of switches between different candidate SRS resource configurations; a fifth maximum number of switches between the different candidate SRS resource configurations during a first duration, wherein the first duration is one of a first period associated with a sub-band full duplex (SBFD) configuration period, a second period associated with a time division duplexing (TDD) slot format pattern, a first number of slots, or a second number of milliseconds; or a minimum time between switches between the different candidate SRS resource configurations, wherein the minimum time is one of a third number slots or a fourth number of milliseconds.

Aspect 7 is the method of any of aspects 2 to 6, wherein the indication indicates the support for the UL resource muting associated with the one or more UL waveforms, and wherein the indication indicates support for one or more of: the UL resource muting associated with a discrete Fourier transform (DFT) spread OFDM (DFT-s-OFDM) waveform for UL; the UL resource muting associated with a cyclic prefix (CP) orthogonal frequency division multiplexing (OFDM) (CP-OFDM) waveform for UL; a same UL resource muting configuration for the DFT-s-OFDM waveform and the CP-OFDM waveform; or different UL resource muting configurations for the DFT-s-OFDM waveform and the CP-OFDM waveform.

Aspect 8 is the method of any of aspects 2 to 7, wherein the indication indicates the support for the UL resource muting associated with the one or more transmission types, and wherein the indication indicates support for one or more of: the UL resource muting for a configured grant (CG) PUSCH; the UL resource muting for a dynamic grant PUSCH; the UL resource muting for a transport block processing over multi-slot (TBoMS) PUSCH; the UL resource muting for a first PUSCH associated with one or more of a first type of repetition or a second type of the repetition; the UL resource muting for a second PUSCH with intra-slot frequency hopping; the UL resource muting for a third PUSCH with inter-slot frequency hopping; or the UL resource muting for a fourth PUSCH associated with one or more of a first type of resource mapping or a second type of the resource mapping.

Aspect 9 is the method of any of aspects 2 to 8, wherein the indication indicates the support for the UL resource muting associated with the maximum number of muted symbols in the time window, and wherein the indication indicates support for one or more of: a first maximum number of muted symbols within the slot; or a second maximum number of muted symbols within a mini-slot.

Aspect 10 is the method of any of aspects 2 to 9, wherein the indication indicates the support for the UL resource muting associated with the slot type, and wherein the indication indicates support for one or more of: the UL resource muting on sub-band full duplex (SBFD) symbols; the UL resource muting on non-SBFD symbols; a same UL resource muting configuration for the SBFD symbols and the non-SBFD symbols; or different UL resource muting configurations for the SBFD symbols and the non-SBFD symbols.

Aspect 11 is the method of any of aspects 2 to 10, wherein the indication indicates the support for the UL resource muting associated with the power boosting of the unmuted PUSCH resources, and wherein the indication indicates that the UE supports the power boosting on the unmuted PUSCH resources transmitted in a first symbol during which the UL resource muting is applied.

Aspect 12 is the method of aspect 11, wherein, based on the power boosting of the unmuted PUSCH resources, a first transmitted power associated with the first symbol and a second transmitted power associated with a second symbol during which the UL resource muting is not applied are a same power.

Aspect 13 is the method of any of aspects 2 to 12, wherein the indication indicates the support for the UL resource muting associated with the minimum frequency domain allocation of the PUSCH to which the UL resource muting may be applied, and wherein the indication indicates a minimum number of frequency resources associated with the PUSCH for which the UE supports the UL resource muting, wherein the frequency resources comprise one of resource blocks or sub-carriers.

Aspect 14 is the method of any of aspects 2 to 13, wherein the indication indicates the support for the UL resource muting associated with the minimum time domain allocation of the PUSCH to which the UL resource muting may be applied, and wherein the indication indicates a minimum number of time-domain resources associated with the PUSCH for which the UE supports the UL resource muting, wherein the time-domain resources comprise one of slots, symbols, or milliseconds.

Aspect 15 is the method of any of aspects 1 to 14, further comprising: transmitting an UL transmission with the UL resource muting based on an UL resource muting configuration from the at least one UL resource muting configuration.

Aspect 16 is the method of any of aspects 1 to 15, wherein the indication of support is a UE capability indication.

Aspect 17 is a method of wireless communication at a network device, comprising: receiving an indication of support by a user equipment (UE) for uplink (UL) resource muting associated with one or more of: UL resource muting activation, a number of UL resource muting time location configurations supported by the UE, UL resource muting time location configuration switching, a use of zero power (ZP) sounding reference signals (SRS) resources for the UL resource muting, one or more UL waveforms, one or more transmission types, a maximum number of muted symbols in a time window, a slot type, power boosting of unmuted physical UL shared channel (PUSCH) resources, a minimum frequency domain allocation of a PUSCH to which the UL resource muting may be applied, or a minimum time domain allocation of the PUSCH to which the UL resource muting may be applied; and transmitting, based on the indication, at least one UL resource muting configuration supported by the UE.

Aspect 18 is the method of aspect 17, wherein the at least one UL resource muting configuration comprises a set of candidate UL resource muting time location configurations configured for the UL resource muting, and wherein the set of candidate UL resource muting time location configurations is associated with one or more of: a first position within a slot of a first muted symbol for the UL resource muting; a second position within the slot of the first muted symbol for the UL resource muting; a third position within the slot of a second muted symbol for the UL resource muting; or a fourth position within the slot of the second muted symbol for the UL resource muting.

Aspect 19 is the method of aspect 18, wherein the indication indicates support by the UE for the UL resource muting associated with the UL resource muting activation, wherein the indication indicates support for one or more of a dynamic activation and a dynamic deactivation of the UL resource muting.

Aspect 20 is the method of any of aspects 18 and 19, wherein the indication indicates the support for the UL resource muting associated with the number of UL resource muting time location configurations supported by the UE, wherein each candidate UL resource muting time location configuration in the set of candidate UL resource muting time location configurations is associated with one of the first muted symbol, the second muted symbol, or a pattern associated with the first muted symbol and the second muted symbol for the UL resource muting, and wherein the indication indicates support for one or more of: a first maximum number of candidate UL resource muting time location configurations associated with the first position of the first muted symbol for the UL resource muting and a second maximum number of candidate UL resource muting time location configurations associated with the second position of the second muted symbol for the UL resource muting; or a third maximum number of candidate UL resource muting time location configurations associated with a pattern comprising the first position of the first muted symbol for the UL resource muting and the second position of the second muted symbol for the UL resource muting.

Aspect 21 is the method of any of aspects 18 to 20, wherein the set of candidate UL resource muting time location configurations comprises a plurality of candidate UL resource muting time location configurations, wherein the indication indicates the support for the UL resource muting associated with the UL resource muting time location configuration switching, and wherein the indication indicates support for one or more of: a first maximum number of switches between different candidate UL resource muting time location configurations in the plurality of candidate UL resource muting time location configurations; a second maximum number of switches between the different candidate UL resource muting time location configurations during a first duration, wherein the first duration is one of a first period associated with a sub-band full duplex (SBFD) configuration period, a second period associated with a time division duplexing (TDD) slot format pattern, a first number of slots, or a second number of milliseconds; or a minimum time between switches between the different candidate UL resource muting time location configurations, wherein the minimum time is one of a third number slots or a fourth number of milliseconds.

Aspect 22 is the method of any of aspects 18 to 21, wherein the indication indicates the support for the UL resource muting associated with the use of ZP SRS resources for the UL resource muting, wherein the set of candidate UL resource muting time location configurations comprises candidate SRS resource configurations, wherein each candidate SRS resource configuration in the set of candidate UL resource muting time location configurations is associated with one of the first muted symbol, the second muted symbol, or a pattern associated with the first muted symbol and the second muted symbol for the UL resource muting, and wherein the indication indicates support for one or more of: a first maximum number of candidate SRS resource configurations associated with the first position of the first muted symbol for the UL resource muting and a second maximum number of candidate SRS resource configurations associated with the second position of the second muted symbol for the UL resource muting; a third maximum number of candidate SRS resource configurations associated with a pattern comprising the first position of the first muted symbol for the UL resource muting and the second position of the second muted symbol for the UL resource muting; a fourth maximum number of switches between different candidate SRS resource configurations; a fifth maximum number of switches between the different candidate SRS resource configurations during a first duration, wherein the first duration is one of a first period associated with a sub-band full duplex (SBFD) configuration period, a second period associated with a time division duplexing (TDD) slot format pattern, a first number of slots, or a second number of milliseconds; or a minimum time between switches between the different candidate SRS resource configurations, wherein the minimum time is one of a third number slots or a fourth number of milliseconds.

Aspect 23 is the method of any of aspects 18 to 22, wherein the indication indicates the support for the UL resource muting associated with the one or more UL waveforms, and wherein the indication indicates support for one or more of: the UL resource muting associated with a discrete Fourier transform (DFT) spread OFDM (DFT-s-OFDM) waveform for UL; the UL resource muting associated with a cyclic prefix (CP) orthogonal frequency division multiplexing (OFDM) (CP-OFDM) waveform for UL; a same UL resource muting configuration for the DFT-s-OFDM waveform and the CP-OFDM waveform; or different UL resource muting configurations for the DFT-s-OFDM waveform and the CP-OFDM waveform.

Aspect 24 is the method of any of aspects 18 to 23, wherein the indication indicates the support for the UL resource muting associated with the one or more transmission types, and wherein the indication indicates support for one or more of: the UL resource muting for a configured grant (CG) PUSCH; the UL resource muting for a dynamic grant PUSCH; the UL resource muting for a transport block processing over multi-slot (TBoMS) PUSCH; the UL resource muting for a first PUSCH associated with one or more of a first type of repetition or a second type of the repetition; the UL resource muting for a second PUSCH with intra-slot frequency hopping; the UL resource muting for a third PUSCH with inter-slot frequency hopping; or the UL resource muting for a fourth PUSCH associated with one or more of a first type of resource mapping or a second type of the resource mapping.

Aspect 25 is the method of any of aspects 18 to 24, wherein the indication indicates the support for the UL resource muting associated with the maximum number of muted symbols in the time window, and wherein the indication indicates support for one or more of: a first maximum number of muted symbols within the slot; or a second maximum number of muted symbols within a mini-slot.

Aspect 26 is the method of any of aspects 18 to 25, wherein the indication indicates the support for the UL resource muting associated with the slot type, and wherein the indication indicates support for one or more of: the UL resource muting on sub-band full duplex (SBFD) symbols; the UL resource muting on non-SBFD symbols; a same UL resource muting configuration for the SBFD symbols and the non-SBFD symbols; or different UL resource muting configurations for the SBFD symbols and the non-SBFD symbols.

Aspect 27 is the method of any of aspects 18 to 26, wherein the indication indicates the support for the UL resource muting associated with the power boosting of the unmuted PUSCH resources, and wherein the indication indicates that the UE supports the power boosting on the unmuted PUSCH resources transmitted in a symbol during which the UL resource muting is applied.

Aspect 28 is the method of any of aspects 18 to 27, wherein the indication indicates the support for the UL resource muting associated with the minimum frequency domain allocation of the PUSCH to which the UL resource muting may be applied, and wherein the indication indicates a minimum number of frequency resources associated with the PUSCH for which the UE supports the UL resource muting, wherein the frequency resources comprise one of resource blocks or sub-carriers.

Aspect 29 is the method of any of aspects 18 to 28, wherein the indication indicates the support for the UL resource muting associated with the minimum time domain allocation of the PUSCH to which the UL resource muting may be applied, and wherein the indication indicates a minimum number of time-domain resources associated with the PUSCH for which the UE supports the UL resource muting, wherein the time-domain resources comprise one of slots, symbols, or milliseconds.

Aspect 30 is the method of any of aspects 17 to 29, further comprising: receiving an UL transmission with UL resource muting based on an UL resource muting configuration from the at least one UL resource muting configuration.

Aspect 31 is the method of any of aspects 17 to 30, wherein the indication of support is a UE capability indication.

Aspect 32 is an apparatus for wireless communication at a device including a memory and at least one processor coupled to the memory and, based at least in part on information stored in the memory, the at least one processor is configured to implement any of aspects 1 to 16.

Aspect 33 is the apparatus of aspect 32, further including a transceiver or an antenna coupled to the at least one processor.

Aspect 34 is an apparatus for wireless communication at a device including means for implementing any of aspects 1 to 16.

Aspect 35 is a computer-readable medium (e.g., a non-transitory computer-readable medium) storing computer executable code, where the code when executed by a processor causes the processor to implement any of aspects 1 to 16.

Aspect 36 is an apparatus for wireless communication at a device including a memory and at least one processor coupled to the memory and, based at least in part on information stored in the memory, the at least one processor is configured to implement any of aspects 17 to 31.

Aspect 37 is the apparatus of aspect 36, further including a transceiver or an antenna coupled to the at least one processor.

Aspect 38 is an apparatus for wireless communication at a device including means for implementing any of aspects 17 to 31.

Aspect 39 is a computer-readable medium (e.g., a non-transitory computer-readable medium) storing computer executable code, where the code when executed by a processor causes the processor to implement any of aspects 17 to 31.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to:
transmit an indication of support by the UE for uplink (UL) resource muting associated with one or more of:
UL resource muting activation,
a number of UL resource muting time location configurations supported by the UE,
UL resource muting time location configuration switching,
a use of zero power (ZP) sounding reference signals (SRS) resources for the UL resource muting,
one or more UL waveforms,
one or more transmission types,
a maximum number of muted symbols in a time window,
a slot type,
power boosting of unmuted physical UL shared channel (PUSCH) resources,
a minimum frequency domain allocation of a PUSCH to which the UL resource muting may be applied, or
a minimum time domain allocation of the PUSCH to which the UL resource muting may be applied; and
receive, based on the indication, at least one UL resource muting configuration supported by the UE.

2. The apparatus of claim 1, wherein the at least one UL resource muting configuration comprises a set of candidate UL resource muting time location configurations configured for the UL resource muting, and wherein the set of candidate UL resource muting time location configurations is associated with one or more of:
a first position within a slot of a first muted symbol for the UL resource muting;
a second position within the slot of the first muted symbol for the UL resource muting;
a third position within the slot of a second muted symbol for the UL resource muting; or
a fourth position within the slot of the second muted symbol for the UL resource muting.

3. The apparatus of claim 2, wherein the indication indicates the support for the UL resource muting associated with the UL resource muting activation, wherein the indication indicates support for one or more of a dynamic activation and a dynamic deactivation of the UL resource muting.

4. The apparatus of claim 2, wherein the indication indicates the support for the UL resource muting associated with the number of UL resource muting time location configurations supported by the UE, wherein each candidate UL resource muting time location configuration in the set of candidate UL resource muting time location configurations is associated with one of the first muted symbol, the second muted symbol, or a pattern associated with the first muted symbol and the second muted symbol for the UL resource muting, and wherein the indication indicates support for one or more of:
a first maximum number of candidate UL resource muting time location configurations associated with the first muted symbol for the UL resource muting and a second maximum number of candidate UL resource muting time location configurations associated with the second muted symbol for the UL resource muting; or
a third maximum number of candidate UL resource muting time location configurations associated with the pattern associated with the first muted symbol and the second muted symbol for the UL resource muting.

5. The apparatus of claim 2, wherein the set of candidate UL resource muting time location configurations comprises a plurality of candidate UL resource muting time location configurations, wherein the indication indicates the support for the UL resource muting associated with the UL resource muting time location configuration switching, and wherein the indication indicates support for one or more of:
a first maximum number of switches between different candidate UL resource muting time location configurations in the plurality of candidate UL resource muting time location configurations;
a second maximum number of switches between the different candidate UL resource muting time location configurations during a first duration, wherein the first duration is one of a first period associated with a sub-band full duplex (SBFD) configuration period, a second period associated with a time division duplexing (TDD) slot format pattern, a first number of slots, or a second number of milliseconds; or
a minimum time between switches between the different candidate UL resource muting time location configurations, wherein the minimum time is one of a third number slots or a fourth number of milliseconds.

6. The apparatus of claim 2, wherein the indication indicates the support for the UL resource muting associated with the use of ZP SRS resources for the UL resource muting, wherein the set of candidate UL resource muting time location configurations comprises candidate SRS resource configurations, wherein each candidate SRS resource configuration in the set of candidate UL resource muting time location configurations is associated with one of the first muted symbol, the second muted symbol, or a pattern associated with the first muted symbol and the second muted symbol for the UL resource muting, and wherein the indication indicates support for one or more of:
a first maximum number of candidate SRS resource configurations associated with the first muted symbol for the UL resource muting and a second maximum number of candidate SRS resource configurations associated with the second muted symbol for the UL resource muting;
a third maximum number of candidate SRS resource configurations associated with the pattern associated with the first muted symbol and the second muted symbol for the UL resource muting;
a fourth maximum number of switches between different candidate SRS resource configurations;
a fifth maximum number of switches between the different candidate SRS resource configurations during a first duration, wherein the first duration is one of a first period associated with a sub-band full duplex (SBFD) configuration period, a second period associated with a time division duplexing (TDD) slot format pattern, a first number of slots, or a second number of milliseconds; or
a minimum time between switches between the different candidate SRS resource configurations, wherein the minimum time is one of a third number slots or a fourth number of milliseconds.

7. The apparatus of claim 2, wherein the indication indicates the support for the UL resource muting associated with the one or more UL waveforms, and wherein the indication indicates support for one or more of:
the UL resource muting associated with a discrete Fourier transform (DFT) spread OFDM (DFT-s-OFDM) waveform for UL;
the UL resource muting associated with a cyclic prefix (CP) orthogonal frequency division multiplexing (OFDM) (CP-OFDM) waveform for UL;
a same UL resource muting configuration for the DFT-s-OFDM waveform and the CP-OFDM waveform; or
different UL resource muting configurations for the DFT-s-OFDM waveform and the CP-OFDM waveform.

8. The apparatus of claim 2, wherein the indication indicates the support for the UL resource muting associated with the one or more transmission types, and wherein the indication indicates support for one or more of:
the UL resource muting for a configured grant (CG) PUSCH;
the UL resource muting for a dynamic grant PUSCH;
the UL resource muting for a transport block processing over multi-slot (TBoMS) PUSCH;
the UL resource muting for a first PUSCH associated with one or more of a first type of repetition or a second type of the repetition;
the UL resource muting for a second PUSCH with intra-slot frequency hopping;
the UL resource muting for a third PUSCH with inter-slot frequency hopping; or
the UL resource muting for a fourth PUSCH associated with one or more of a first type of resource mapping or a second type of the resource mapping.

9. The apparatus of claim 2, wherein the indication indicates the support for the UL resource muting associated with the maximum number of muted symbols in the time window, and wherein the indication indicates support for one or more of:
a first maximum number of muted symbols within the slot; or
a second maximum number of muted symbols within a mini-slot.

10. The apparatus of claim 2, wherein the indication indicates the support for the UL resource muting associated with the slot type, and wherein the indication indicates support for one or more of:
the UL resource muting on sub-band full duplex (SBFD) symbols;
the UL resource muting on non-SBFD symbols;
a same UL resource muting configuration for the SBFD symbols and the non-SBFD symbols; or
different UL resource muting configurations for the SBFD symbols and the non-SBFD symbols.

11. The apparatus of claim 2, wherein the indication indicates the support for the UL resource muting associated with the power boosting of the unmuted PUSCH resources, and wherein the indication indicates that the UE supports the power boosting on the unmuted PUSCH resources transmitted in a first symbol during which the UL resource muting is applied.

12. The apparatus of claim 11, wherein, based on the power boosting of the unmuted PUSCH resources, a first transmitted power associated with the first symbol and a second transmitted power associated with a second symbol during which the UL resource muting is not applied are a same power.

13. The apparatus of claim 2, wherein the indication indicates the support for the UL resource muting associated with the minimum frequency domain allocation of the PUSCH to which the UL resource muting may be applied, and wherein the indication indicates a minimum number of frequency resources associated with the PUSCH for which the UE supports the UL resource muting, wherein the frequency resources comprise one of resource blocks or sub-carriers.

14. The apparatus of claim 2, wherein the indication indicates the support for the UL resource muting associated with the minimum time domain allocation of the PUSCH to which the UL resource muting may be applied, and wherein the indication indicates a minimum number of time-domain resources associated with the PUSCH for which the UE supports the UL resource muting, wherein the time-domain resources comprise one of slots, symbols, or milliseconds.

15. The apparatus of claim 1, further comprising a transceiver coupled to the at least one processor, the transceiver being configured to:
transmit an UL transmission with the UL resource muting based on an UL resource muting configuration from the at least one UL resource muting configuration.

16. The apparatus of claim 1, wherein the indication of support is a UE capability indication.

17. An apparatus for wireless communication at a network node, comprising:
at least one memory; and
at least one processor coupled to the at least one memory and, based at least in part on stored information that is stored in the at least one memory, the at least one processor, individually or in any combination, is configured to:
receive an indication of support by a user equipment (UE) for uplink (UL) resource muting associated with one or more of:
UL resource muting activation,
a number of UL resource muting time location configurations supported by the UE,
UL resource muting time location configuration switching,
a use of zero power (ZP) sounding reference signals (SRS) resources for the UL resource muting,
one or more UL waveforms,
one or more transmission types,
a maximum number of muted symbols in a time window,
a slot type,
power boosting of unmuted physical UL shared channel (PUSCH) resources,
a minimum frequency domain allocation of a PUSCH to which the UL resource muting may be applied, or
a minimum time domain allocation of the PUSCH to which the UL resource muting may be applied; and
transmit, based on the indication, at least one UL resource muting configuration supported by the UE.

18. The apparatus of claim 17, wherein the at least one UL resource muting configuration comprises a set of candidate UL resource muting time location configurations configured for the UL resource muting, and wherein the set of candidate UL resource muting time location configurations is associated with one or more of:
a first position within a slot of a first muted symbol for the UL resource muting;
a second position within the slot of the first muted symbol for the UL resource muting;
a third position within the slot of a second muted symbol for the UL resource muting; or
a fourth position within the slot of the second muted symbol for the UL resource muting.

19. A method of wireless communication at a user equipment (UE), comprising:
transmitting an indication of support by the UE for uplink (UL) resource muting associated with one or more of:
UL resource muting activation,
a number of UL resource muting time location configurations supported by the UE,
UL resource muting time location configuration switching,
a use of zero power (ZP) sounding reference signals (SRS) resources for the UL resource muting,
one or more UL waveforms,
one or more transmission types,
a maximum number of muted symbols in a time window,
a slot type,
power boosting of unmuted physical UL shared channel (PUSCH) resources,
a minimum frequency domain allocation of a PUSCH to which the UL resource muting may be applied, or
a minimum time domain allocation of the PUSCH to which the UL resource muting may be applied; and
receiving, based on the indication, at least one UL resource muting configuration supported by the UE.

20. The method of claim 19, wherein the at least one UL resource muting configuration comprises a set of candidate UL resource muting time location configurations configured for the UL resource muting, and wherein the set of candidate UL resource muting time location configurations is associated with one or more of:
a first position within a slot of a first muted symbol for the UL resource muting;
a second position within the slot of the first muted symbol for the UL resource muting;
a third position within the slot of a second muted symbol for the UL resource muting; or
a fourth position within the slot of the second muted symbol for the UL resource muting.
